(19) United States
(12) Patent Application Publication
(10) Pub. No.: US 2015/0174485 A1
(43) Pub. Date: Jun. 25, 2015

(54) GAME CONTROL DEVICE, GAME CONTROL METHOD, PROGRAM, RECORDING MEDIUM, GAME SYSTEM

(71) Applicant: KONAMI DIGITAL ENTERTAINMENT CO., LTD., Tokyo (JP)

(72) Inventors: Takashi SUENAGA, Kawasaki-shi (JP); Taku ENDO, Kawasaki-shi (JP); Hiroyuki OWAKU, Tokyo (JP); Ryosaku UENO, Yokohama-shi (JP)

(73) Assignee: KONAMI DIGITAL ENTERTAINMENT CO., LTD.

(21) Appl. No.: 14/579,715

(22) Filed: Dec. 22, 2014

Related U.S. Application Data
(63) Continuation of application No. PCT/JP2013/066334, filed on Jun. 13, 2013.

(30) Foreign Application Priority Data
Jun. 25, 2012 (JP) 2012-142384

(51) Int. Cl. A63F 13/31

(52) U.S. Cl. CPC A63F 13/31

(57) ABSTRACT

The first game control device according to the present invention includes: an executor configured to execute the first game; a determiner configured to determine whether at least one of a status of execution in the first game played by a user, and a degree of association in the first game between the user and another user satisfies a condition; a provider configured to provide a second game control device that executes a second game, with first information indicating that the condition is satisfied, after the determiner determines that the condition has been satisfied; and a notifier configured to notify the user that the user can receive a benefit in the second game, after the determiner determines that the condition has been satisfied.

### CROSS-REFERENCE TO RELATED APPLICATIONS

This application is a continuation of International Application PCT/JP2013/066334, with an international filing date of Jun. 13, 2013, which claims the benefit of priority of the prior Japanese Patent Application No. 2012-142384, filed on Jun. 25, 2012, the entire contents International Application PCT/JP2013/066334 and Japanese Patent Application No. 2012-142384 are incorporated herein by reference.

### FIELD

The present invention relates to a technique for controlling a progress of a game for respective users.

### BACKGROUND

Recently, so-called social network games have become widespread as applications executable in a social networking service (SNS). As an example of the social network games, a digital card game (Dragon collection (registered trademark)) is disclosed in a Japanese game magazine “Appli Style, Vol. 5 (Eastpress Co., Ltd.) p. 7-8.”

### SUMMARY OF THE INVENTION

As many social network games are provided recently, a system has been demanded which motivates a user to select and play a specific game from many social network games. That is, a system that leads a user to play a specific game, particularly a new game that users have never played, has been demanded.

The present invention has been devised in consideration of the above. An object of the present invention is to provide a first game control device, a game control method, a program, a recording medium, and a game system that lead a user to play a specific game.

An aspect of the present invention is a first game control device for a first game including:

an executor configured to execute the first game;

a determiner configured to determine whether at least one of a status of execution in the first game played by a user, and a degree of association in the first game between the user and another user satisfies a condition;

a provider configured to provide a second game control device that executes a second game, with first information indicating that the condition is satisfied, after the determiner determines that the condition has been satisfied; and

a notifier configured to notify the user that the user can receive a benefit in the second game, after the determiner determines that the condition has been satisfied.

The first game and the second game may be executable after completion of user registration, and a number of users having registered in the first game is less than a number of users having registered in the second game. Further, the provider may be configured to temporarily record the first information in a buffer, to transmit the first information in the buffer to the second game control device, and to repeat transmission of the first information until completion.

The first game and the second game may be executable after completion of user registration, and a number of users having registered in the first game is less than a number of users having registered in the second game, and the provider may be configured to transmit the first information to the second game control device in response to an input of the user.

In the first game control device, the provider may be configured to simultaneously transmit the first information to the second game control device at set time intervals.

In the first game control device, the condition may be that a level reaches a predetermined value, the level indicating a degree of progression by the user in the first game or a degree of progression by the user in an event of the first game.

In the first game control device, the benefit may be increased as the level increases.

The first game and the second game may be executable after completion of user registration. Further, the provider may be configured to provide the second game control device with the first information, irrespective of whether the user is registered in the second game, and the notifier may be configured to notify the user, irrespective of whether the user is registered in the second game.

In the first game control device, the determiner may be configured to limit a user to be determined, based on registered information for the user.

In the first game control device, the registered information may be at least one of sex and age.

### BRIEF DESCRIPTION OF THE DRAWING

Referring now to the attached drawings which form a part of this disclosure:

FIG. 1 illustrates a basic configuration diagram of a game system according to an embodiment.

FIG. 2A illustrates an external appearance example of a communication terminal according to the embodiment.

FIG. 2B illustrates an external appearance example of a communication terminal according to the embodiment.

FIG. 3 is a block diagram of a configuration of a communication terminal according to the embodiment.

FIG. 4 is a block diagram of a configuration of a game server according to the embodiment.

FIG. 5 is a block diagram of a configuration of a database server according to the embodiment.

FIG. 6 illustrates an exemplary configuration of a user database according to the embodiment.

FIG. 7 illustrates an exemplary configuration of a present database according to the embodiment.

FIG. 8 illustrates an exemplary configuration of a benefit management database according to the embodiment.

FIG. 9 illustrates an example of a series of web pages that are displayed on the communication terminal of a user.

FIG. 10 illustrates an example of a series of web pages that are displayed on the communication terminal of a user.

FIG. 11 illustrates an example of a series of web pages that are displayed on the communication terminal of a user.

FIG. 12 illustrates an example of a series of web pages that are displayed on the communication terminal of a user.

FIG. 13 is a functional block diagram for explaining functions that play main rolls in the first game control device according to the embodiment.

FIG. 14 illustrates an exemplary configuration of benefit data and a benefit data queue.

FIG. 15 is a sequence chart for displaying a campaign page on the communication terminal.

FIG. 16 is a sequence chart for processing steps based on a determination result for a condition for benefits in a joint campaign according to the present embodiment.

FIG. 17 is a sequence chart for processing steps based on a determination result for a condition for benefits in the joint campaign according to the present embodiment.

FIG. 18 is a sequence chart for processing steps of receiving the benefit in the joint campaign according to the present embodiment.

FIG. 19 illustrates an example of a series of web pages that are displayed on the communication terminal of a user according to a modification of the present embodiment.

FIG. 20 is a sequence chart for processing steps based on a determination result for a condition for benefits in a joint campaign according to a modification of the present embodiment.

FIG. 21 is a sequence chart for processing steps based on a determination result for a condition for benefits in a joint campaign according to a modification of the present embodiment.

FIG. 22A illustrates an example in which the functions are distributed to the communication terminal, and the game server and the database server, with regard to the first game control device according to the embodiment.

FIG. 22B illustrates an example in which the functions are distributed to the communication terminal, and the game server and the database server, with regard to the first game control device according to the embodiment.

### DETAILED DESCRIPTION OF THE EMBODIMENTS

The embodiment of the present embodiment will be described below.

### (1) Configuration of Game System

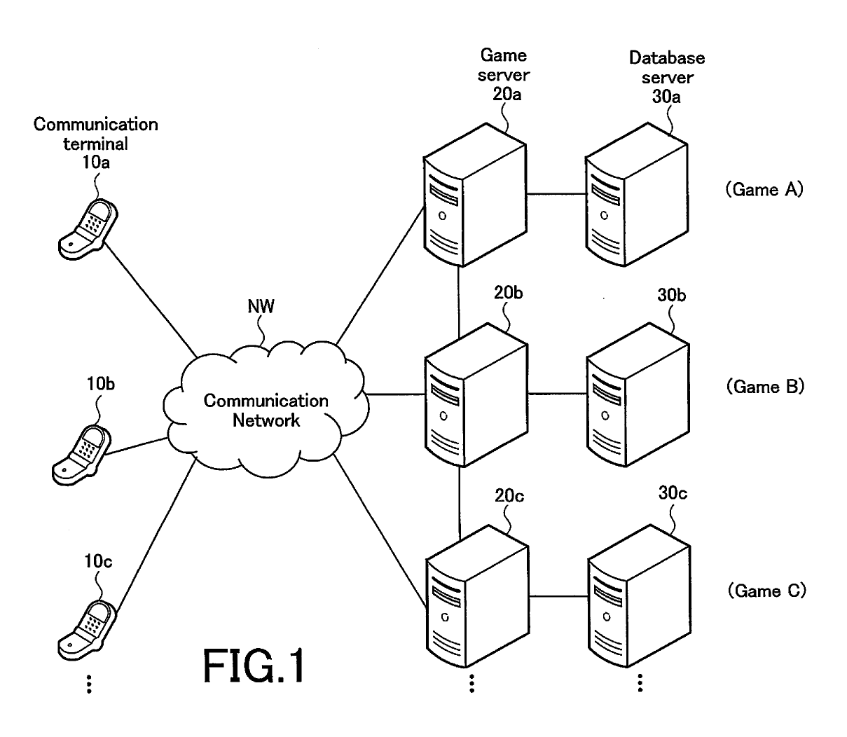

FIG. 1 illustrates an exemplary system configuration of a game system according to embodiments. As illustrated in FIG. 1, the game system includes a plurality of communication terminals 10a, 10b, 10c, and etc. that are connectable to a communication network NW such as the Internet, a game server 20a, 20b, 20c, and etc. that are connectable to the communication network NW, and a database server 30a, 30b, 30c, and etc. Each of the communication terminals 10a, 10b, 10c, and etc. is a communication terminal operated by an individual user, such as a mobile terminal, a smartphone, a personal digital assistant (PDA), a personal computer, or a television receiver including a two-way communication function (including a so-called multi-functional smart TV). It should be noted that the communication terminals 10a, 10b, 10c and etc. may be hereinafter collectively referred to as “communication terminal(s) 10.” Similarly, the game servers 20a, 20b, 20c and etc. may be hereinafter collectively referred to as “game server(s) 20.” The database servers 30a, 30b, 30c and etc. may be hereinafter collectively referred to as “database server(s) 30.”

With this game system, the game server 20a is configured to be able to communicate with the communication terminal 10 as a client. The game server 20a and the database server 30a provide the communication terminal 10 with gaming service for a game A. The game server 20b is configured to be able to communicate with the communication terminal 10 as a client. The game server 20b and the database server 30b provide the communication terminal 10 with gaming service for a game B. The game server 20c is configured to be able to communicate with the communication terminal 10 as a client. The game server 20c and the database server 30c provide the communication terminal 10 with gaming service for a game C.

The game server 20 is embedded with an application operable on a web browser as a game application in the game system. The database server 30 stores a variety of information for executing the games as described below. The database server 30 is connected to the game servers 20 by means of a wired connection for example for reading and writing the information.

The communication terminal 10 includes a web browser that is able to display a web page provided by the game server 20. A user executes a game application by performing an operation for selecting a button, etc. (an instruction button, for example) on the web page displayed on the communication terminal 10.

In addition to the game server 20, an authentication server may be provided for authenticating respective users of the communication terminals 10, although not illustrated in FIG. 1. Further, if providing a plurality of the game servers 20 for receiving accesses from a large number of the communication terminals 10, a load balancer may be provided for regulating loads among the plurality of game servers 20. Furthermore, the game server 20 may be configured as a single server device or as a plurality of server devices to which functions are distributed.

### (2) Communication Terminal Configuration

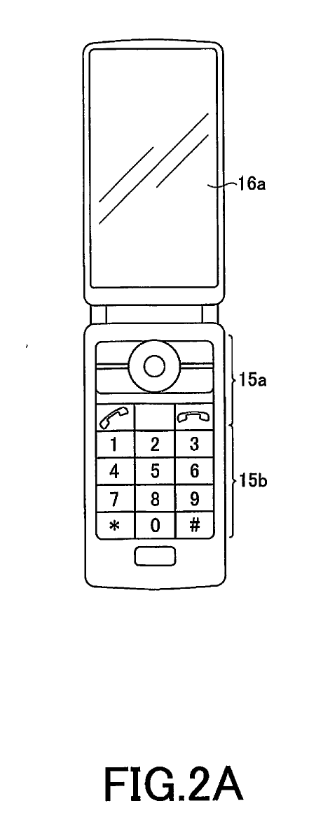

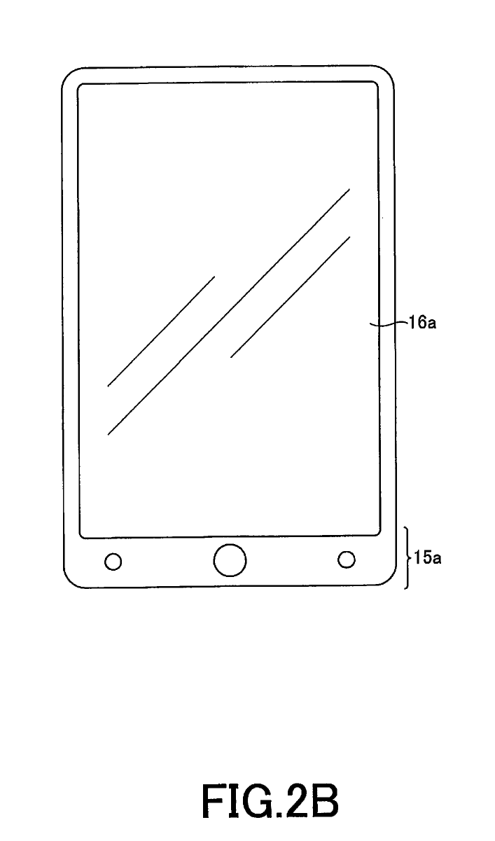

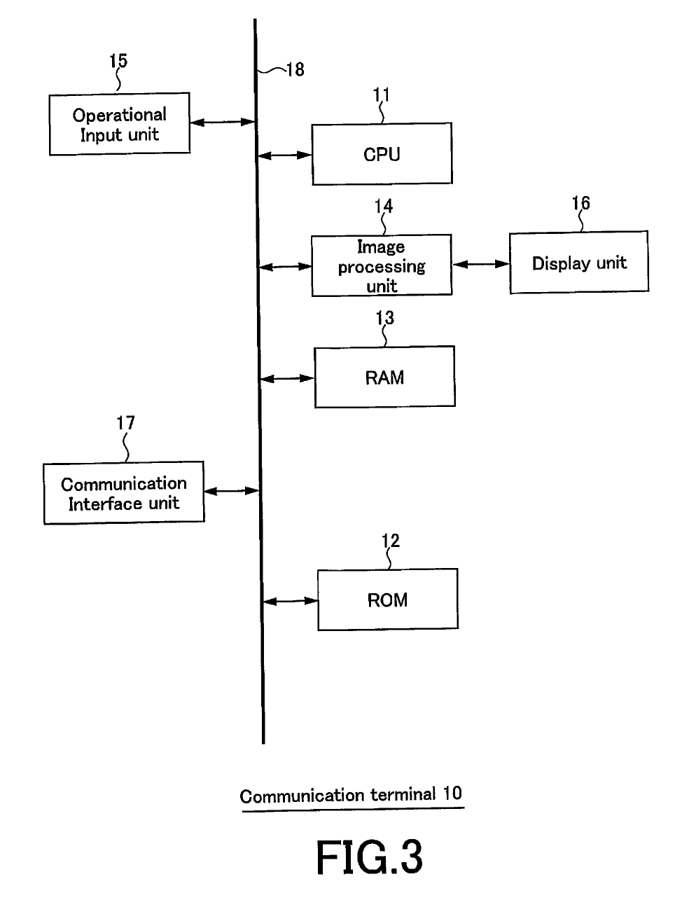

The communication terminal 10 will be hereinafter explained with reference to FIGS. 2A, 2B, and 3.

FIGS. 2A and 2B illustrate exemplary appearances of the communication terminal 10. FIG. 2A illustrates a communication terminal with a button input system such as a foldable communication terminal (mobile telephone). FIG. 2B illustrates a communication terminal with a touch panel input system such as a smartphone. FIG. 3 is a configuration block diagram of the communication terminal 10.

As represented in FIG. 3, each communication terminal 10 includes a central processing unit (CPU) 11, a read-only memory (ROM) 12, a random access memory (RAM) 13, an image processing unit 14, an operational input unit 15, a display unit 16, and a communication interface unit 17 as a signal reception unit. Further, each communication terminal 10 includes a bus 18 for transmitting control signals or data signals among the components.

The CPU 11 loads a web browser stored in the ROM 12 into the RAM 13 and runs the web browser therein. The CPU 11 acquires data for displaying a web page from the game server 20 through the communication interface unit 17 on the basis of an appropriately specified uniform resource locator (URL) that is inputted by a user using the operational input unit 15 and the like. The acquired data is data of objects such as images associated with a hypertext markup language (HTML) document and the HTML document (hereinafter collectively referred to as “HTML data” on an as-needed basis). The CPU 11 then interprets the acquired HTML data. It should be noted that each communication terminal 10 may be embedded with a variety of plug-ins for extending browsing functions of the web browser. An example of such plug-ins is a flash player provided by Adobe systems Incorporated (United States).

In acquiring the HTML data, the CPU 11 transmits an access request message to the game server 20 through the communication interface unit 17. The access request message herein includes either a preliminarily registered user ID (user identification information) or a user ID inputted through the operational input unit 15.

The web browser displays on the display unit 16 a web page provided by the game server 20 through the image processing unit 14 on the basis of the acquired HTML data. Further, when either a Hyperlink or a button on the web page is selected by a user operating the operational input unit 15, the web browser sends a request to the game server 20 (that is, a request for updating a web page; HTTP request) to transmit new HTML data for displaying the web page in accordance with the selection.

The image processing unit 14 displays a web page on the display unit 16 on the basis of image data for display to be provided from the CPU 11 as an analysis result of the HTML data. For example, the display unit 16 is a liquid crystal display (LCD) monitor including thin-film transistors arranged in a matrix manner on a pixel-by-pixel basis. The display unit 16 displays the image of the web page by driving the thin-film transistors on the basis of the image data for display on a display screen 16a.

In the case in which the mobile terminal 10 is a communication terminal to which a button input method (see FIG. 2A) applies, the operational input unit 15 is equipped with a button group 15a and a button group 15b. The button group 15a includes a plurality of operational input buttons such as a directional instruction button and a confirmation button for receiving user operational inputs. The button group 15b includes a plurality of operational input buttons such as an alphanumeric keypad and the like. The operational input unit 15 also includes an interface circuit for recognizing pressing (operating) the buttons as inputs and outputting the inputs to the CPU 11. For example, the direction instructional button is provided for instructing the CPU 11 to scroll and display a web page displayed on the display unit 16. The confirmation button is provided for instructing the CPU 11 to select one of a plurality of hyperlinks or buttons displayed on a web page. The selected hyperlink or button may be activated (e.g., highlighted). When the communication terminal 10 is a small portable terminal, the aforementioned buttons are preferably disposed on the front face of the communication terminal 10 to allow a user to easily operate (click) the buttons with the thumb of the hand holding the communication terminal 10. In the example illustrated in FIG. 2A, the button group 15b is arranged below the button group 15a and includes a plurality of operational input buttons depicted as “0” to “9”, “*”, “#” (an alphanumeric keypad).

In the case in which the mobile terminal 10 is a communication terminal to which a touch panel input method (see FIG. 2B) applies, the operational input unit 15 receives touch panel method inputs inputted by mainly touching the display screen 16a with a finger or a pen. The touch panel input method may be a known method such as a capacitance method. As illustrated in FIG. 2B, the communication terminal 10 may be provided with a button group 15a despite having the touch panel input method.

In the case in which a button input method applies to the mobile terminal 10 for example, a selection operation of a button on a web page displayed on the communication terminal 10 is performed by the following steps: selecting a button on the web page with a pressing operation of the direction instructional button and subsequently confirming the selected button with a pressing operation of the confirmation button. In the case in which a touch panel input method applies to the mobile terminal 10 for example, the selection operation is conducted by indicating (touch operation) with a finger or pen a position of a button on the display screen 16a on which the web page is displayed.

### (3) Game Server Configuration

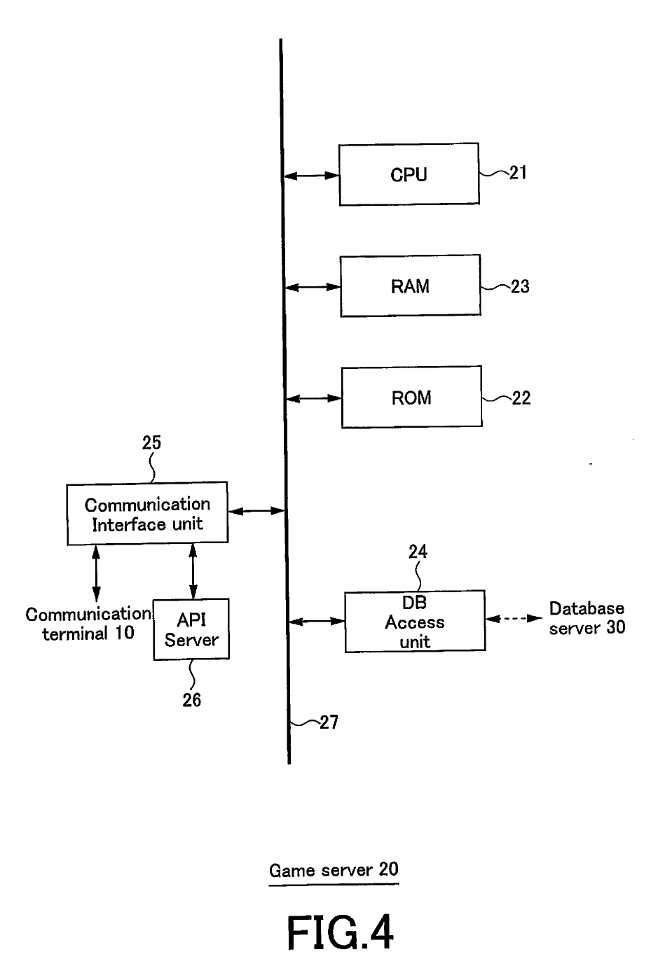

The configuration of the game server 20 will be explained with reference to FIG. 4

For example, the game server 20 manages a website of a game including a plurality of hierarchically structured web pages. The game server 20 provides a web service of the game to the communication terminals 10. As illustrated in FIG. 4, the game server 20 includes a CPU 21, a ROM 22, a RAM 23, a database (DB) access unit 24, a communication interface unit 25, and an Application Programming Interface (API) server 26. Further, the game server 20 includes a bus 27 for transmitting control signals or data signals among the components. It should be noted that the game server 20 may have the same hardware structure as general-purpose web servers.

The ROM 22 stores an application program that provides the service of displaying a HTML document and objects such as images (i.e., displaying a web page) to the web browser of the communication terminal 10 as a client. A variety of data referenceable by the CPU 21 is stored in the ROM 22 in addition to the application program.

The CPU 21 loads a game program stored in the ROM 22 into the RAM 23 and runs the loaded game program. The CPU 21 also performs a variety of processing through the communication interface unit 25.

For example, the CPU 21 communicates with the web browser of the communication terminal 10 according to HTTP through the communication interface unit 25. For example, the CPU 21 performs data processing and computation based on a HTTP request (including a user's selection result of a hyper link or a button on a web page, for example) received through the communication interface unit 25 from the communication terminal 10. The CPU 21 returns a HTTP response including a processing result to the web browser of the communication terminal 10. The HTTP response includes HTML data for updating a web page. In the case in which the game server 20 is supposed to perform authentication processing for a user of the communication terminal 10, the CPU 21 performs the authentication processing.

The database access unit 24 is an interface used when the CPU 21 performs data reading and data writing with respect to the database server 30.

The API server 26 is embedded with Web API, and communicates with an API server of other game server according to HTTP. For example, the API server 26 issues a request for a processing step to the API server of the other game server according to HTTP. The other API server, which receives the request, returns a processing result to the API server as a request source. In the present embodiment, the API server 26 issues a request including user information for a specific user (benefit data as will be described later, for example) to an API server of other game server. The other API server, which receives the request, performs a processing step based on the user information included in the request.

Note that FIG. 4 illustrates a case in which the API server 26 is incorporated into the game server 20; however, the API server 26 may be a separate device from the game server 20.

### (4) Database Server Configuration

The database server 30 as a memory device can be realized by a general-purpose storage such as a high-capacity hard disk drive, a redundant array of inexpensive disks (RAID) or other form of device. Databases inside the database server 30 are configured to allow reading and writing of data by the CPU 21 through the database access unit 24 of the game server 20.

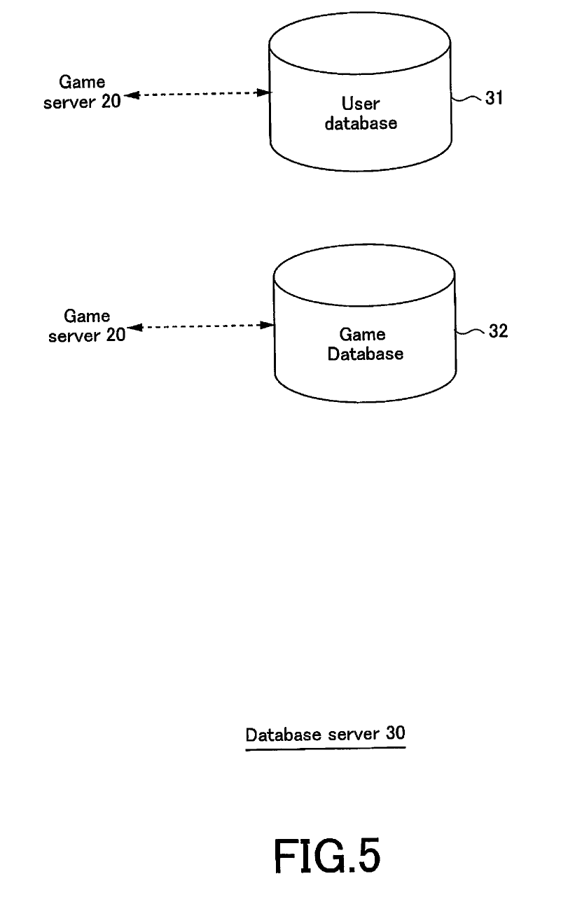

A configuration of the database server 30 may be different depending on a game to be executed; however, for the purpose of simplicity in explanation, all database servers 30 include the common configuration illustrated in FIG. 5. As illustrated in FIG. 5, the database server 30 includes a user database 31 and a game database 32.

The game executed by the game server 20 of the present embodiment is not limited to a game of a specific type. For convenience sake of the following explanation, a digital card game will be considered as an exemplary game. Image of a game character is displayed on a card that is used in this digital card game. That is, the game servers 20a, 20b, etc. executes digital card games A, B, etc. respectively.

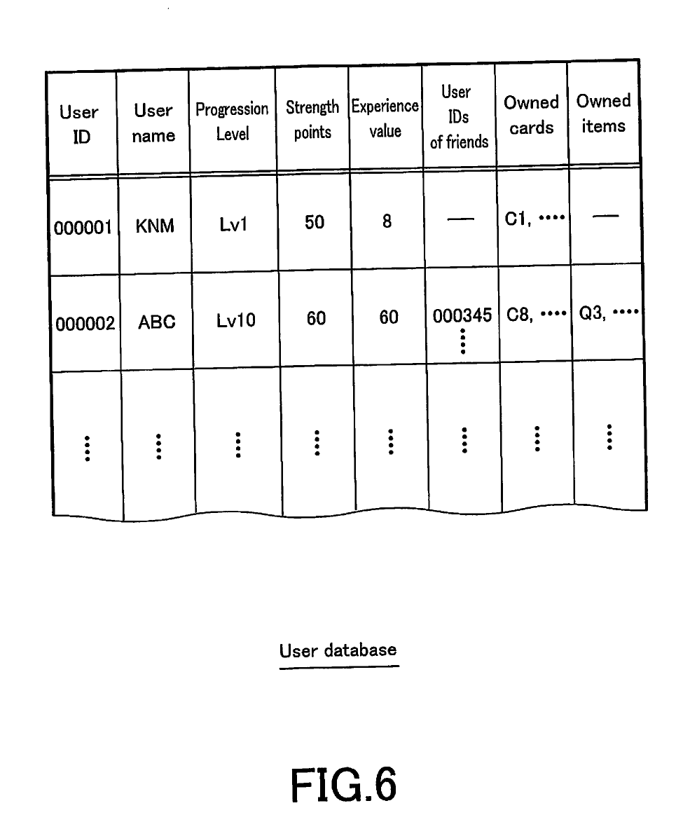

FIG. 6 illustrates an exemplary configuration of a user database 31 that is applied to the digital card game of the present embodiment. The digital card game may be referred to as “the game” simply or “the game of the present embodiment” hereinafter. Data included in the user database 31 may be updated by the game server 20. In the following explanation, data for each user ID (user identification information) or for each user name identifying a user may be collectively referred to as “user data.” Data of respective fields of the user data is as follows.

### User Name

“User Name” represents a user name for identifying a user of the communication terminal 10 while executing the game. The user name is a text of a certain length or shorter determined in advance by the user. Same as user ID, the user name may be managed with an identical user name for an identical user in the games A, B, C, etc., or may be set to different user names for an identical user in the games A, B, C, etc.

### Progression Level

“Progression level” is data indicating a degree of progression of a user in respective games. The progression level a value ranging from Lv1 (Level 1) to Lv100 (Level 100). When an experience value reaches a predetermined value, the progression level increases by one.

### Strength Points

“Strength points” are points that are required in performing a quest that will be described later in the game of the present embodiment. The strength points decreases as the quest is performed, while the strength points recover (increase) each time a certain period of time elapses.

### Experience Value

“Experience value” is a value that increases as the quest is performed. If the experience value reaches a predetermined value (100 for example), the progression level increases by one and the experience value is reset (that is, becomes zero).

### User IDs of Friends

“User IDs of friends” indicates user IDs of users who are associated with a user as friends.

### Owned Cards

“Owned cards” is data of warrior card(s) that a user owns in the game. An example of such data is an identifier indicating a kind of a card, such as C1. Each card may be associated with parameters (that is, capability value such as attack power and defense power) that are referred to in a battle of the game.

### Owned Items

“Owned items” is data of item(s) that a user owns in the game. An example of such data is an identifier indicating a kind of an item, such as Q3.

In the explanation of the present embodiment, it is assumed that respective databases 30a, 30b, etc. have the user database 31 of the same configuration, and that respective games A, B, etc. include functions for executing a quest which will be described later. Contents of the respective games may be different; however, as will be clear later, the contents per se of the respective game are not essential elements in the present embodiment.

In the explanation of the present embodiment, it is assumed that the game servers 20a, 20b, 20c, etc. are embedded on a common platform, and that an identical user is managed with an identical user ID in the games A, B, C, etc.; however, the present invention is not limited to such case. As long as relations among user IDs for different games are known in respective game servers 20, different user IDs can be used in each of the games for an identical user.

In the present embodiment, a joint campaign with the game B (referred to as “joint campaign” hereinafter) is held in the game A in order to guide a user to play the game A (namely, a first game). In the joint campaign, the user is provided with a benefit that is receivable in the game B (namely, a second game), in accordance with a status of execution of the user in the game A. This joint campaign may be held for a limited period of time for the purpose of prompting a user to try to play the game A faster.

Referring now back to FIG. 5, the game database 32 stores and updates information with regard to progression of the game executed by the game server 20. The information with regard to progression of the game may include various types of information according to nature of the game. In the game of the present embodiment, that information may include a result of the quest, which will be described later.

The game database 32 stores and updates a present database and a benefit management database with reference to the joint campaign described above. More specifically, in the case in which the joint campaign of the game A and the game B is held, the benefit management database is provided at least in the game database 32 of the database server 30a while the present database is provided in the game database 32 of the database server 30b.

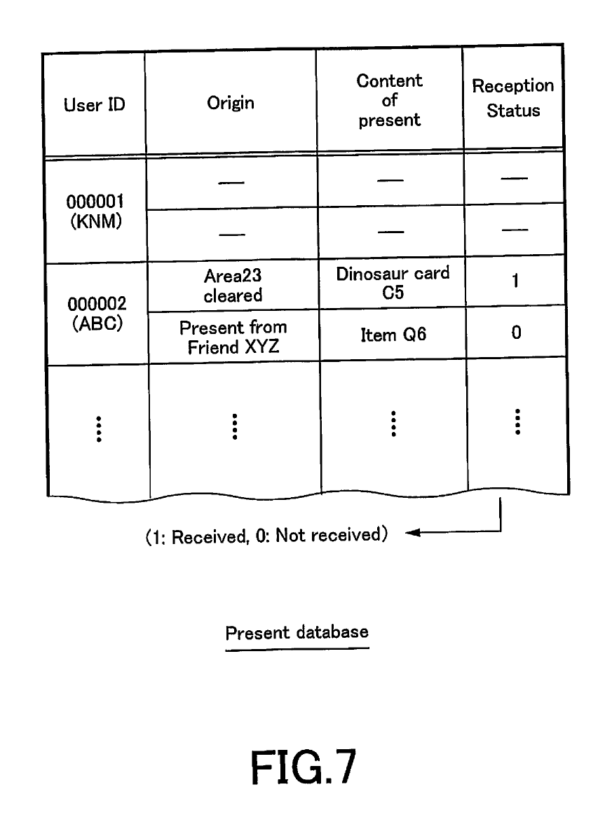

The present database records information with regard to presents to respective users. A present may be: a card, an item, or points, etc. provided as a benefit from a game provider, or a card, an item, etc. provided from other user (friend, for example) as a gift or via trade. FIG. 7 illustrates an exemplary configuration of the present database. The present database illustrated in FIG. 7 includes for each user ID: information of an origin of a present, information of a content of the present (identifier of an item or a card provided to a user, for example), and a flag indicating the user's reception status of the present (“1”: Received, “0”: Not received).

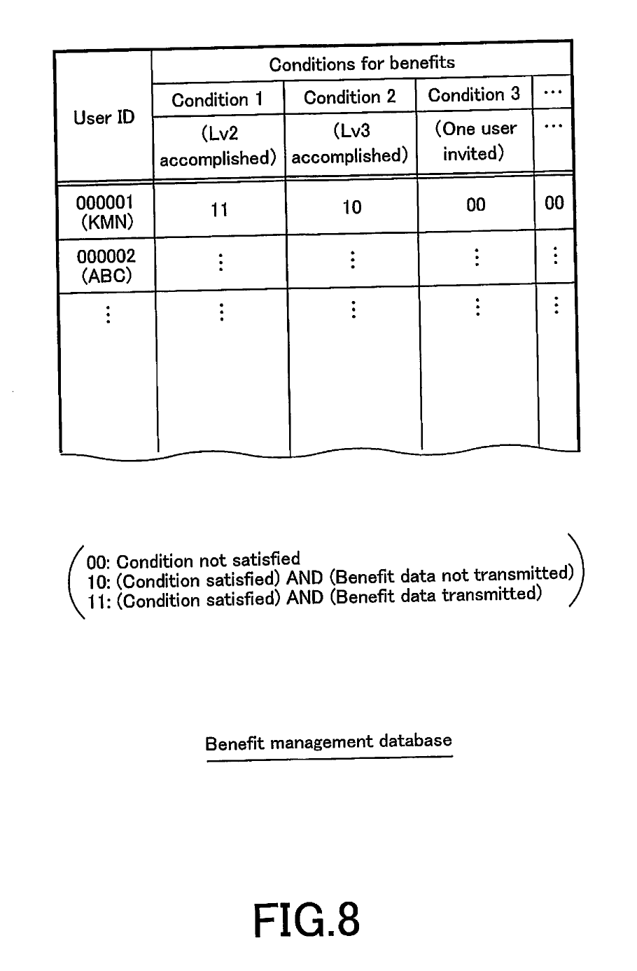

The benefit management database is a database for managing benefits provided to users in the above joint campaign. FIG. 8 illustrates an exemplary configuration of the benefit management database. The benefit management database illustrated in FIG. 8 manages for each user ID and for each of a plurality of conditions for providing a benefit in the joint campaign with the game B: information with regard to whether each of the plurality of conditions for providing a benefit has been satisfied, and information with regard to whether is first information transmitted. The first information indicates that each of the plurality of conditions for providing a benefit has been satisfied. The first information will be also referred to as “benefit data” later. For example, in an example of FIG. 8, two bits data is written into the benefit management database. That is, “00” is written if a condition has not been satisfied. “10” is written if a condition has been satisfied while the later-described benefit data has not been transmitted. “11” is written if a condition has been satisfied while the later-described benefit data has been transmitted.

### (5) Game According the Present Embodiment

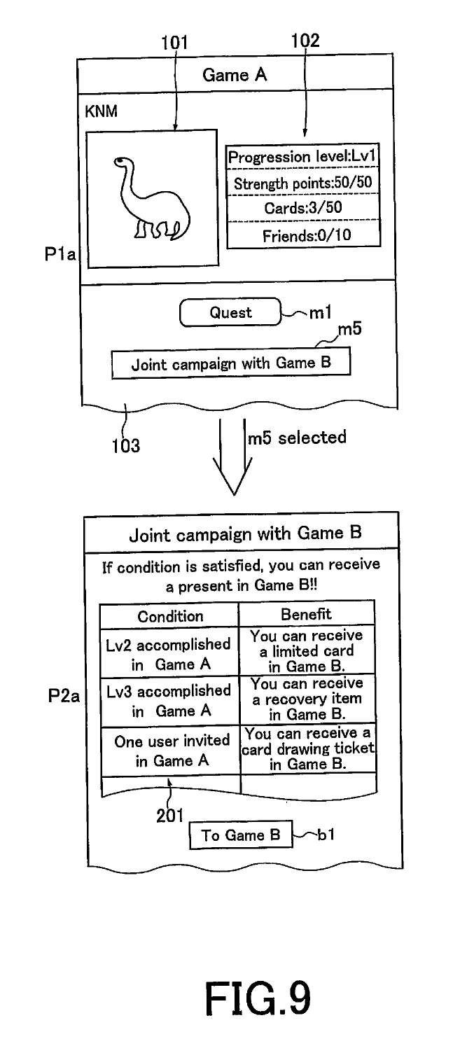

The game of the present embodiment will be described hereinafter with reference to FIGS. 9 to 12.

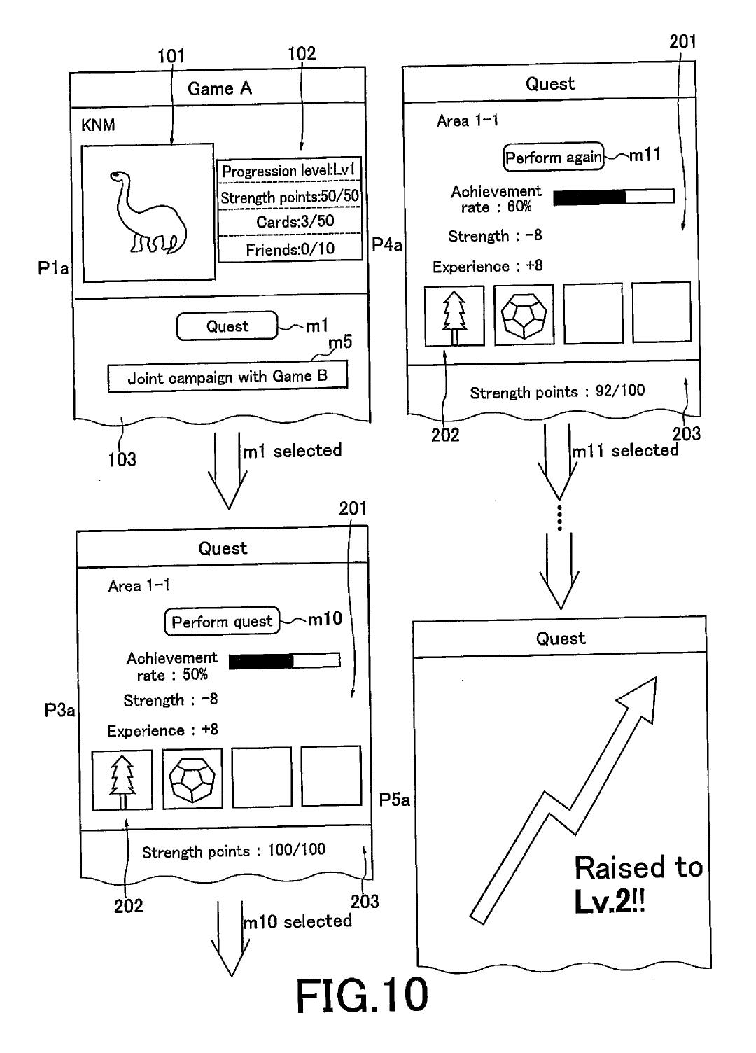

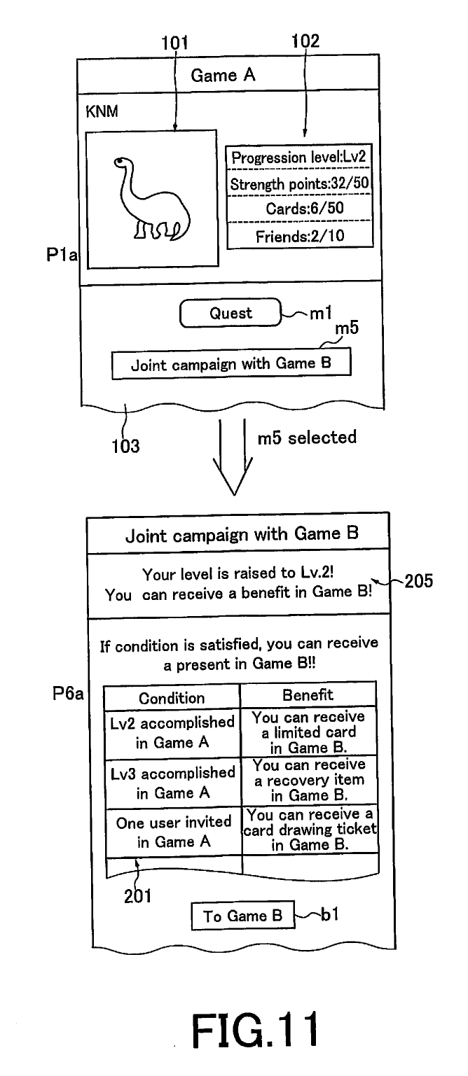

FIG. 9 illustrates an example of web pages in which a content of the joint campaign with the game B is displayed. FIG. 10 illustrates an example of web pages that are displayed when a user plays the game A. FIG. 11 illustrates an example of web pages, in the game A of the present embodiment, that are displayed after a condition (that is, a condition for benefits) in the joint campaign with the game B has been satisfied. FIG. 11 illustrates an example of web pages, in the game B of the present embodiment, that are displayed when a user receives a benefit that is obtained by playing the game A.

In the following explanation, buttons and marks and the like displayed on the web pages displayed on the communication terminal 10 are arranged in preferable positions on the web pages. The positions on the display screen of the buttons and marks and the like made visible by the communication terminal 10 may be changed with a scrolling operation of the web page by the user using a direction instructional button or touch panel operation.

A web page P1a of FIG. 9 is an example of a top page of the game A in the present embodiment. The top page is configured for respective user IDs. The top page illustrated in FIG. 9 includes a character image area 101, a user data area 102, and a menu area 103.

The character image area 101 is an area in which a character image is displayed. A character image to be displayed is selected by a user from a plurality of character images that respectively correspond to a plurality of cards included in user data of user ID to be processed.

The user data area 102 is an area in which respective fields of user data for a user ID to be processed is displayed (see FIG. 6). The displayed fields are: Progression level, Strength points, Cards, and Friends. A number of cards owned by a user is displayed in the field of “Cards” in the user data area 102. As illustrated in FIG. 9, display of “3/50” as the number of cards indicates that a number of cards owned by a user to be processed is three while the maximum number of cards that the user could own is fifty. Display of “50/50” as the strength points indicates that the present strength points of the user to be processed is fifty while the maximum value of strength points for the user is fifty at the present. The field of “Friends” indicates a number of friends of the user to be processed. As illustrated in FIG. 9, display of “0/10” as the number of friends indicates that a number of friends of the user to be processed is zero while the maximum number of friends that the user could register is ten.

It is assumed that, in the web page P1a illustrated in FIG. 9, the user to be processed has just started playing the game A, and accordingly the progression level for the user is Lv1 (default value).

The menu area 103 is an area for displaying buttons that each correspond to each of a plurality of functions provided in the game A of the present embodiment, and buttons that each correspond to a specific event, a campaign, etc. An example of a button that corresponds to one of the plurality of functions provided in the game A of the present embodiment is, but not limited to, a buttom m1 (“Quest”) is displayed in the web page P1a. Buttons for performing other processing steps may be displayed. For example, a button of “Battle” may be displayed for performing a battle against other user by use of cards.

In the game A of the present embodiment, a button m5 (“Joint campaign with game B”) for displaying a web page (which may be referred to as “campaign page” hereinafter) with regard to the joint campaign with the game B is displayed in the menu area 103.

If the button m5 is selected on the web page P1a of FIG. 9, the updated web page P2a will be displayed. In the web page P2a, a content for guiding the joint campaign with the game B may be displayed. If the user to be processed can receive a benefit in the game B, a content of the benefit may be displayed.

A “recovery item”, which is exemplified as a content of a benefit, is an item that increases strength points of a user up to the maximum value in the game. As will be described later, the strength points decreases as the quest is performed. With the recovery item used, the quest can be performed more frequently in a short period, and accordingly a user can advance the game farther. A “card drawing ticket” is, for example, a ticket that allows a user to draw a card one time, in the case in which a function for drawing a card is available in the game B.

As illustrated in FIG. 9, a web banner b1 (“To Game B!”) may be displayed to link to the game B. The web page P2a of FIG. 9 is a campaign page in the case in which there are not benefits receivable in the game B with respect to the user to be processed.

If the buttom m1 (“Quest”) is selected on the web page P1a of FIG. 10, the updated web page P3a will be displayed. In the web page P3a, a button m10 (“Perform quest”) for exploring an area by the user is included. If the button m10 is selected, the updated web page P3 will be displayed. A buttom m11 (“Perform again”) is displayed in the web page P3 so that exploration can be continued. Every time the button m10 or the buttom m11 is selected, achievement rate increases by a fixed or a randomly determined value. If the achievement rate in the area reaches 100%, then exploration in the area terminates and the user can advance to the next area. Every time the button m10 or the buttom m11 is selected, the strength points of the user is consumed by a predetermined value (“eight” as the predetermined value in FIG. 10, for example) and an experience value increases by a predetermined value (“eight” as the predetermined value in FIG. 10, for example). A plurality of areas may be provided for exploration. In the quest processing, it may be configured such that, every time the button m10 or the buttom m11 is selected, a variety of cards and items in the game may be given to the user with a fixed or a randomly determined probability. For example, cards or items that the user has obtained are displayed in a display area 202 in the web page.

Every time the quest is performed, the strength points are consumed (reduced). A point display area 203 is provided to display the strength points that the user owns after the points have been reduced. For example, the strength points have been reduced from 100 to 92 with a change of a web page from P1a to P4a. If the button m11 is repeatedly selected in the web page P4a, the experience value will reach a predetermined value (100, for example) and the progression level will be raised from Lv1 to Lv2. Consequently, the updated web page P5a will be displayed.

If the buttom m11 is repeatedly selected in the web page P4a, the strength points will be reduced as described above. If the strength points becomes less than a value (8, for example) that requires to perform one time quest, then the subsequent quest cannot be performed. In this case, in order to play the quest again, the user needs to wait until the strength points recovers (increases) as time elapses.

If the button m5 is selected in the web page P1a of FIG. 11 after the progression level is raised to Lv2, the updated web page P6a (campaign page) will be displayed as illustrated in FIG. 11. Different from the web page P2a of FIG. 9, the web page P6a is provided with a display area 205 that includes a text indicating that the user is given a benefit due to the progression level that has been raised to Lv2.

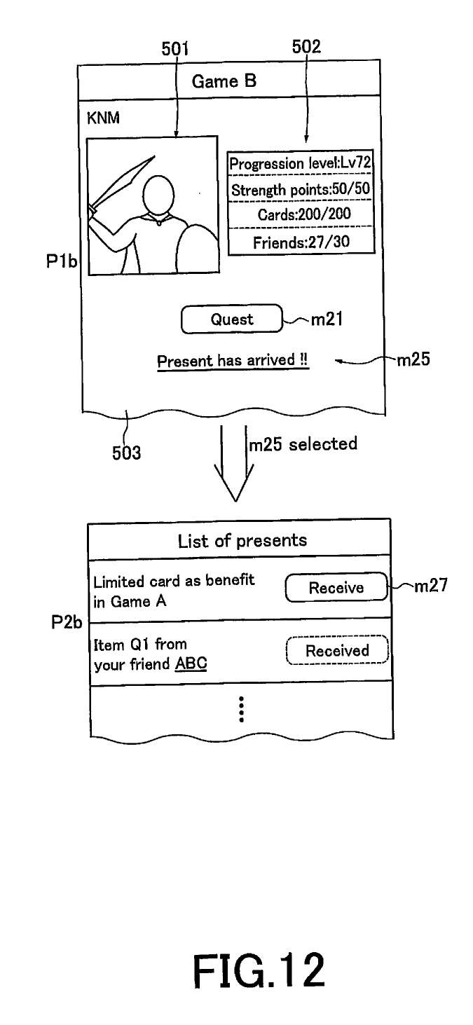

If the web banner b1 (“To Game B!”) is selected in the web page P6a of FIG. 11, a top page of the game B will be displayed for the user to be processed, as illustrated with P1b of FIG. 12. In this example, display arrangement of the top page P1b in the game B is the same as that of the top page P1a in the game A; however, display arrangement of the top page P1b in the game B may be different from that of the top page P1a in the game A. Same as the game A, a button m21 (“Quest”) for performing quest is displayed as an example of a button that corresponds to a function provided in the game B of the present embodiment.

In the top page P1b of the game B, a button m25 (“Present has arrived!!”) will be displayed if there are any presents that have not been received by the user. With the button m25 selected, the updated web page P2b will be displayed for a list of presents. In the list of presents, a button m27 (“Receive”) for receiving a present or a text indicating that a present has been received, is displayed in association with respective presents to the user to be processed. Here, as illustrated in the web page P6a of FIG. 11, a benefit that the user to be processed is able to receive in the game B through the joint campaign in the game A, is associated with the button m27. In this example, such benefit is to receive a limited card like a rare card. If the button m27 is selected in the web page P2b, the user can receive the present that corresponds to the selected button m27.

### (6) Overview of Functions of Game Control Devices

Next, respective processing in the game control device to realize the game of the present embodiment will be described.

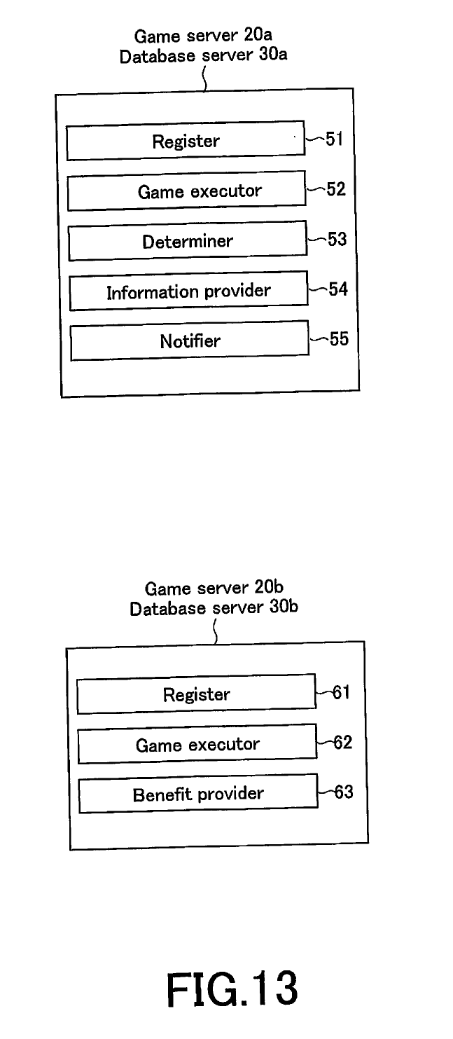

In the present embodiment, the game control device is configured, for example, by the game server 20 and the database server 30. Hereinafter, functions performed by the game control device of the present embodiment will be described with reference to FIG. 13 in the case in which the above-described game of the present embodiment is applied. FIG. 13 includes: a functional block diagram having respective functions for executing the game A that are realized by the game server 20a and the database server 30a; and a functional block diagram having respective functions for executing the game B that are realized by the game server 20b and the database server 30b. In the present embodiment, the first game control device is configured with the game server 20a and the database server 30a, while the second game control device is configured with the game server 20b and the database server 30b.

Note that the registers 51, 61 are not mandatory elements for the present invention, but elements preferably provided respectively for the first and second game control devices according to the present embodiment.

The register 51 includes a function for recognizing a registration request from a user and performing registration processing in response to an operational input to the communication terminal 10 on a web page for example that is provided to the communication terminal 10. The registration processing is performed when a user performs user registration in the game of the present embodiment.

The function of the register 51 may be realized, for example, as described below. The CPU 21 of the game server 20a receives a registration request message from the communication terminal 10 through the communication interface unit 25. The web page provided by the game server 20 may be configured so that a registration request message is automatically generated by a certain operation (e.g., a selection of a certain button, or input of text of user ID and password, etc.) to the communication terminal 10 on the web page. Information (e.g., identification information of the communication terminal 10 as a transmission source such as UID (Unique Identifier), a mail address, etc.) may be included in the registration request message. Alternatively, in the case in which the user plays the other game(s) from the same service provider, the registration request message may include the user ID of that user.

If the CPU 21 receives the registration request message in which a user ID is not included, the CPU 21 issues a new user ID and processes the new user ID, and then transmits a message to the communication terminal 10 indicating the fact that the registration has been completed. If the CPU 21 receives the registration request message in which a user ID is included in the registration request message, the CPU 21 processes that user ID, and then transmits a registration completion message to the communication terminal 10. The registration includes processing steps performed by the CPU 21 for generating user data that corresponds to user ID and for storing the user data in the user database 31. Once the registration for a user is completed, the user corresponding to the user ID can start playing the game of the present embodiment. If the CPU 21 receives a HTTP request for logging in from the communication terminal 10 of a user after registration for the user is completed, the CPU 21 acquires identification information, or user ID and a password from the HTTP request. The CPU 21 then performs authentication processing by comparing the acquired identification information, or user ID and a password, with data that is recorded in the user database 31 for example.

The register 51 also includes a function for associating a user with one or more users. For example, when receiving an application based on a user ID, the register 51 associates the user ID with the other user ID. That is, the register 51, in response to application based on a user ID, registers the other user ID (namely, the other user) as “friend.”

The function of the register 51 will be realized for example as described below. The CPU 21 of the game server 20a receives an application message (application) that specifies a user ID (or the corresponding user name) to desirably be friends with, from the communication terminal 10 of the user corresponding to a user ID through the communication interface unit 25. The transmission of the application message may be preset as a function of the web page provided to the communication terminal 10 of the user.

Upon receiving the application message, the CPU 21 transmits HTML data to the communication terminal 10 corresponding to the user ID, when access occurs based on the user ID included in the application message. The transmitted HTML data is for displaying a web page to request for replying whether or not the application on the basis of the other user ID is approved. The CPU 21 registers both users as friends if a message of approval of the application is returned. Specifically, the CPU 21 writes the data (a user ID of the friend) in the “User IDs of friends” field (see FIG. 6) of the user data of the two corresponding user IDs in the user database 31. Note that, in the case in which approval from other user is not required based on an application from a user, these two users may be registered as friends in response to an operation by the user while playing the game. For example, users who have played an identical stage or an area, or users who have played a battle together, may be registered as users who are associated each other in the game, namely friends. Alternatively, users who transmits greeting messages to each other at predetermined times may be automatically registered as friends. If a battle play is embedded in a game, users who play battles together at predetermined times may be automatically registered as friends.

Instead of directly associating a user with other user, each of a plurality of users may be associated with an identical group (guild, etc.) and resultantly a user in the group may be associated with any other user in the group. For example, if user A makes an application as described to user B who is associated with a specific group and receives approval from user B, then user A is made associated with the specific group. With an application and approval with respect to a user in a specific user, a user in a group may be associated with other user in the identical group irrespective of whether a direct application and approval have been made.

In the present embodiment, an example is disclosed in which registration of users as friends is realized by writing data into the user database 31; however, registration of users as friends is not limited to such example. Data with regard to friends may be written to an external memory device in the network accessible from the game server 20.

The game executor 52 includes a function for executing the game A.

In the present embodiment, the game A is executed by transmitting HTML data for sequentially updating a web page displayed on the communication terminal 10, in response to an operation by a user to the communication terminal 10. The CPU 21 of the game server 20a receives a HTTP request from the communication terminal 10 through the communication interface unit 25, and performs processing required based on the HTTP request. The CPU 21 then transmits a HTTP response to the communication terminal 10. The transmitted HTTP response includes HTML data that is a result of the processing performed.

A content of processing that is performed based on the HTTP request may be different depending on a function provided in the game. The following is an example of the content of processing.

In the case in which the quest, which was explained with reference to FIG. 10 for example, is performed, if the CPU 21 of the game server 20a receives a HTTP request including a content of a selection operation by a user (a selection result of the button m10 or the buttom m11, for example), the CPU 21 updates the achievement rate, the strength points, and the experience value. For example, the CPU 21 of the game server 20a loads data of the achievement rate, the strength points, and the experience value, to the RAM 23, and updates the data in the RAM 23 during a period in which the quest is performed. After the quest terminates, the CPU 21 overwrites the updated data in the RAM 23 into the data in the database server 30a.

In the case in which a battle is performed between a user and other user by use of cards, the CPU 21 of the game server 20a compares parameters (attack power and defense power, for example) of cards used by the user and the other user in the battle. The CPU 21 then determines a result of the battle based on a result of the comparison.

The determiner 53 includes a function for determining whether at least one of a status of execution in the game A (namely, a first game) played by a user to be processed, and a degree of association in the game A between the user and another user satisfies a condition for benefits (namely, a condition).

The condition for benefits is preferably, but not limited to, a condition that motivates a user to try to play the game A, that is, a condition that guides a user to the game A. For example, “status of execution in the game A satisfies a condition for benefits” by the user may refer to: a condition under which a progression level or total playtime in the game A exceeds a prescribed value; or a condition under which display or processing steps for a tutorial of the game A has completed if the tutorial is supposed to be displayed for a user accessing to the game A for the first time.

“Degree of association in the game A between the user and other user satisfies a condition for benefits” may refer to: a condition under which the user invites the other user to the game A and the other user is registered in the game A; a condition under which the user is associated with the other user as friends in the game A; or a condition under which a degree of intimacy between the user and the other user is equal to or higher than a prescribed level.

Note that the degree of intimacy indicates numerical information with regard to a degree of association between two friends that is determined based on a criteria. For example, the degree of intimacy may be set as high when a specific value increases. Such specific value may be: a frequency (cheering frequency) of transmission and reception with regard to cheering messages between the two friends; a number of times of transmission and reception with regard to presents such as items usable in the game; or the like.

The function of the determiner 53 will be realized for example as described below. Every time the CPU 21 of the game server 20a receives a HTTP request from the communication terminal 10, the CPU 21 accesses to the benefit management database and determines whether each of conditions for benefits for which data of “00” (Condition for benefits is not satisfied.) is written has been satisfied by the user to be processed. Determination may be different for each of the conditions for benefits.

In the case in which a condition for benefits is that a progression level of a user to be processed reaches a prescribed level for example, the CPU 21 of the game server 20a accesses to user data of the user to read the progression level. The CPU 21 then determines that the condition has been satisfied if the progression level, which has been read, is equal to or higher than a prescribed level.

In the case in which a condition for benefits is that a tutorial of the game A is configured with a plurality of web pages that are displayed hierarchically or in stages in response to a selection operation by a user, the CPU 21 of the game server 20a may determine that the condition has been satisfied if transmission has been completed with regard to HTML data for a web page that is displayed last among the plurality of web pages that configures the tutorial.

In the case in which a condition for benefits is that other user is registered based on invitation from a user to be processed, determination will be performed as follows. That is, in the case in which a user is registered in the game A due to invitation from other user, the CPU 21 of the game server 20a records data that associates the inviting user with the invited user, in user data for example. The CPU 21 then determines whether the condition has been satisfied, referring to that data.

If a condition for benefits has become satisfied by a user to be processed, the CPU 21 of the game server 20a rewrites data corresponding to the condition in the benefit management database, from “00” (Condition for benefits is not satisfied.) to “10” (Condition for benefits is satisfied, and benefit data is not transmitted.).

The provider 54 includes a function for providing the game server 20b (namely, a second game control device) that executes the game B (namely, a second game), with benefit data (namely, first information) indicating that the condition for benefits is satisfied, after the determiner 53 determines that the condition for benefits has been satisfied.

The function of the provider 54 will be realized as described below. The CPU 21 of the game server 20a accesses to the benefit management database to generate benefit data that corresponds to each of conditions for benefits for which “10” (Condition for benefits is satisfied, and benefit data is not transmitted.) is written. The CPU 21 then adds (or writes) the benefit data into a benefit data queue (namely, buffer) in the RAM 23.

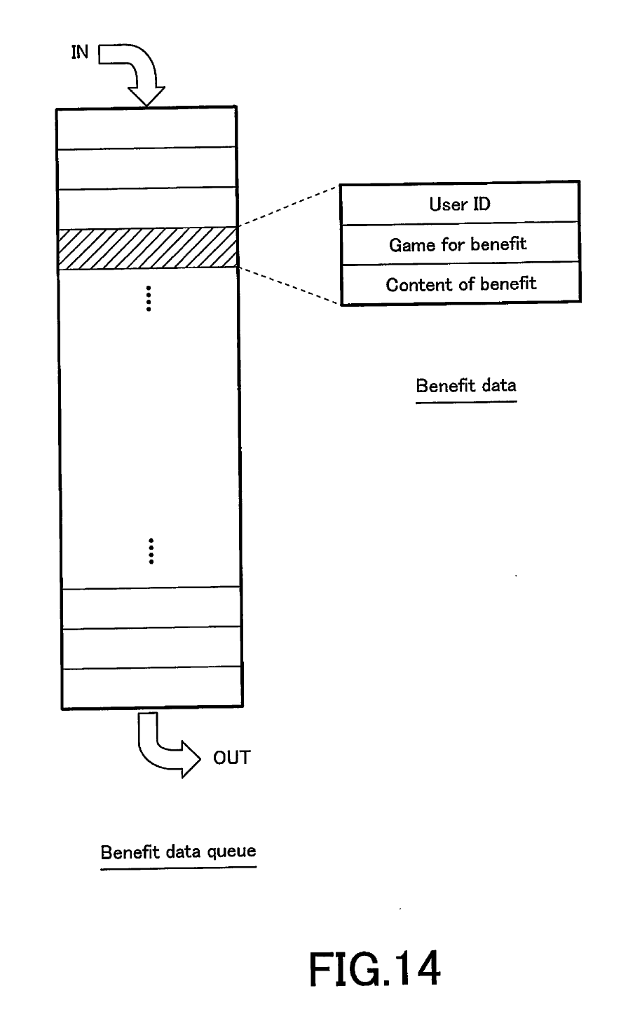

Then benefit data and the benefit data queue will be explained with reference to FIG. 14. FIG. 14 illustrates an exemplary configuration of the benefit data and the benefit data queue. The benefit data is configured with data of “user ID”, “game for benefit”, and “content of benefit.” The “game for benefit” indicates a game in which a benefit is provided. The game for benefit is the game B in an example of the present embodiment. The “content of benefit” indicates a content of a benefit that is receivable in the game for benefit, which is the game B. The benefit data queue is stored in an address group of a region of the RAM 23 for temporarily memorizing a plurality of benefit data. The CPU 21 writes benefit data in each address and sequentially reads benefit data to be transmitted.

The CPU 21 of the game server 20a refers to the benefit management database to generate benefit data, based on user ID and conditions for benefits that correspond to data of “10” (Condition for benefits is satisfied, and benefit data is not transmitted.). The CPU 21 then writes the benefit data into the benefit data queue.

After reading benefit data to be transmitted from the benefit data queue, the CPU 21 of the game server 20a controls the API server 26 such that a request including the benefit data, which has been read, is transmitted to the API server 26 of the game server 20b. Note that the API server 26 of the game server 20a receives a response from the API server 26 of the game server 20b. The response includes a reception result (reception successful, or reception failed) with regard to the benefit data.

After transmission of the benefit data is completed, the CPU 21 of the game server 20a accesses to the benefit management database to rewrite data corresponding to the benefit data that has been transmitted, from “10” (Condition for benefits is satisfied, and benefit data is not transmitted.) to “11” (Condition for benefits is satisfied, and benefit data is transmitted.).

The notifier 55 includes a function for notifying a user that the user can receive a benefit in the game B (namely, the second game), if the determiner 53 determines that a condition for benefits has been satisfied.

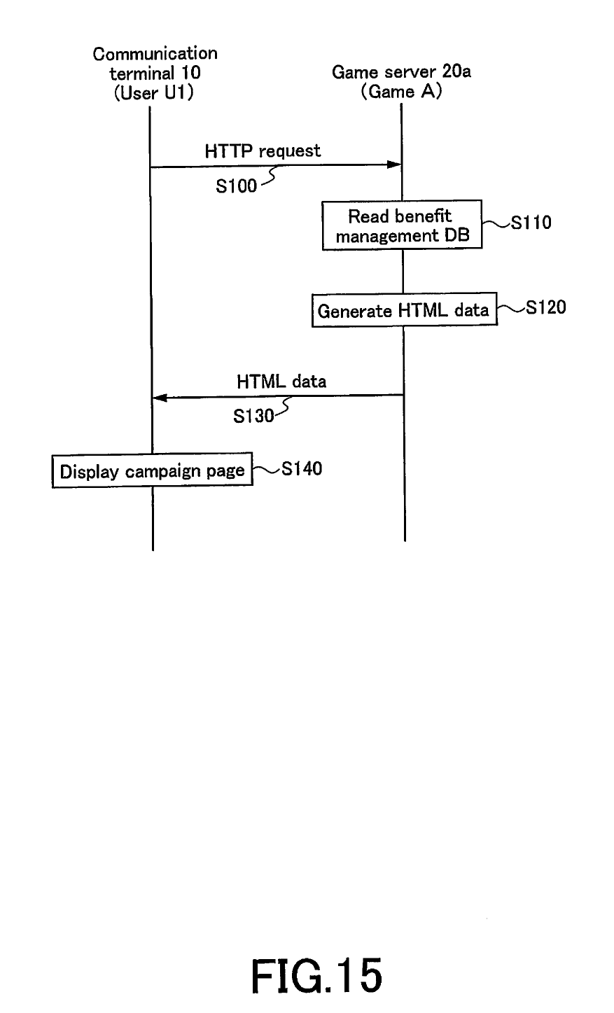

An example of how the function of the notifier 55 is realized will be explained with reference to FIG. 15. FIG. 15 is a sequence chart for displaying a campaign page on the communication terminal 10. Note that the user to be processed is user U1 in FIG. 15.

In FIG. 15, if recognizing that the button m5 has been selected in the top page (web page P1a of FIG. 11, for example) by user U1, the communication terminal 10 transmits a HTTP request to the game server 20a (Step S100). The transmitted HTTP request includes a result of the selection operation. The CPU 21 of the game server 20a, based on the HTML data which it has received, reads data corresponding to each of the conditions for benefits with regard to user ID of user U1, from the benefit management database (namely, benefit management DB) (Step S110). Then, based on information indicated by the data that has been read, that is, information of whether each of the conditions for benefits has been satisfied and whether benefit data has been transmitted, the CPU 21 generates HTML data such that the display area 205 in a campaign page includes an appropriate text (Step S120). The CPU 21 then transmits the HTML data to the communication terminal 10 (Step S130). The communication terminal 10 interprets the HTML data which it has received, and displays the campaign page as illustrated by the web page P6a of FIG. 11 (Step S140). If any condition for benefits has been satisfied by user U1, a benefit will be displayed in the campaign page.

The register 61 and the game executor 62 includes functions provided for the game B, which are the same functions as those of the register 51 and the game executor 52 respectively. Hence, explanation of how the functions of the register 61 and the game executor 62 are realized, will be omitted. Note that, as described above, a content of the game B that is executed by the game executor 62, may be different from that of the game A.

The benefit provider 63 includes a function for providing a user with a benefit in the game B (namely, second game) based on benefit data (namely, first information).

The function of the benefit provider 63 will be realized as described below. If the CPU 21 of the game server 20b receives benefit data, through the API server, from the game server 20a, the CPU 21 writes new data in the present database based on the received benefit data. In this case, the CPU 21 writes a code indicating that the benefit derives from the joint campaign, into the field of “Origin” that corresponds to user ID included in the benefit data. The CPU 21 writes a content of the benefit (identifier indicating a kind of a card, for example) included in the benefit data, into the field of “Content of present.” The CPU 21 writes “0” (Not received) into the field of “Reception status.”

If the CPU 21 of the game server 20b recognizes a selection operation (selection operation to the button m27, for example) for receiving a benefit in a web page (the web page P2b of FIG. 12, for example) that includes a list of presents in the game B, the CPU 21 associates a content of the benefit with the user to be processed. For example, in the case of a card as a content of the benefit, the CPU 21 of the game server 20b accesses to the user data of the user to be processed and writes the card as the benefit in the field of “Owned cards.” The CPU 21 then accesses to the present database to rewrite data in the field of “Reception status” corresponding to the benefit to be received by the user (that is, the benefit to be provided to the user), from “0” (Not received) to “1” (Received).

The CPU 21 of the game server 20b generates HTML data in response to the selection operation (selection operation to the button m27, for example) for receiving the benefit, and transmits the HTML data to the communication terminal 10. A web page (not illustrated) that is displayed based on the HTML data preferably includes a text indicating that the benefit has been provided to the user.

### (7) Main Processing Flow of the First and the Second Game Control Devices of the Present Embodiment

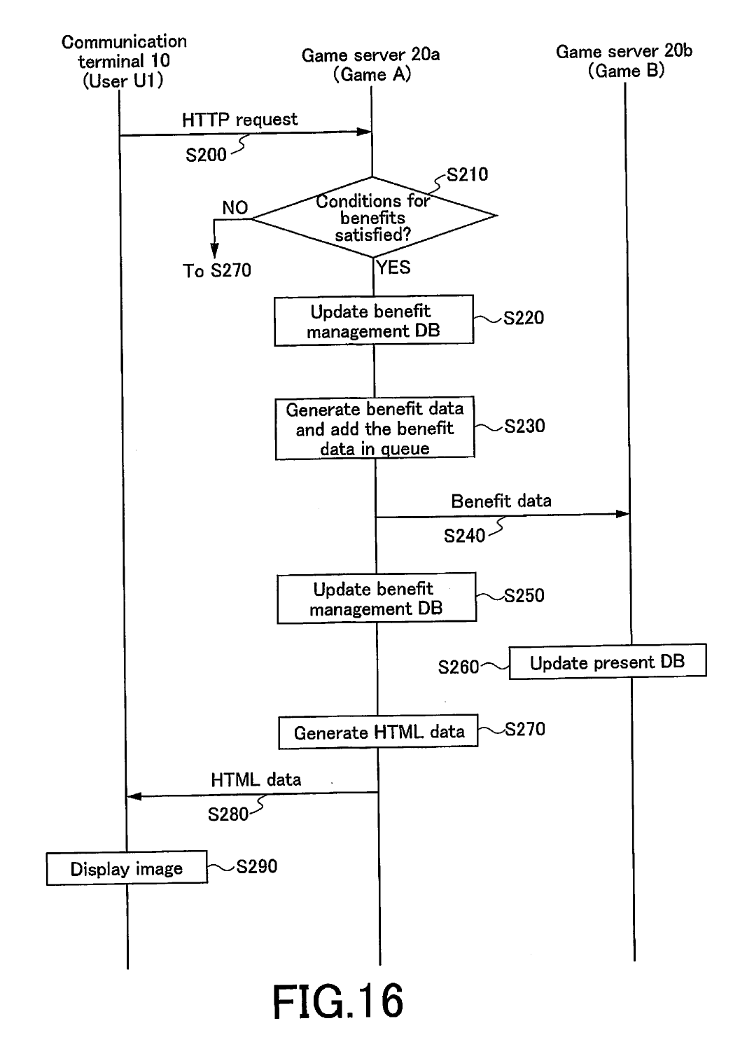

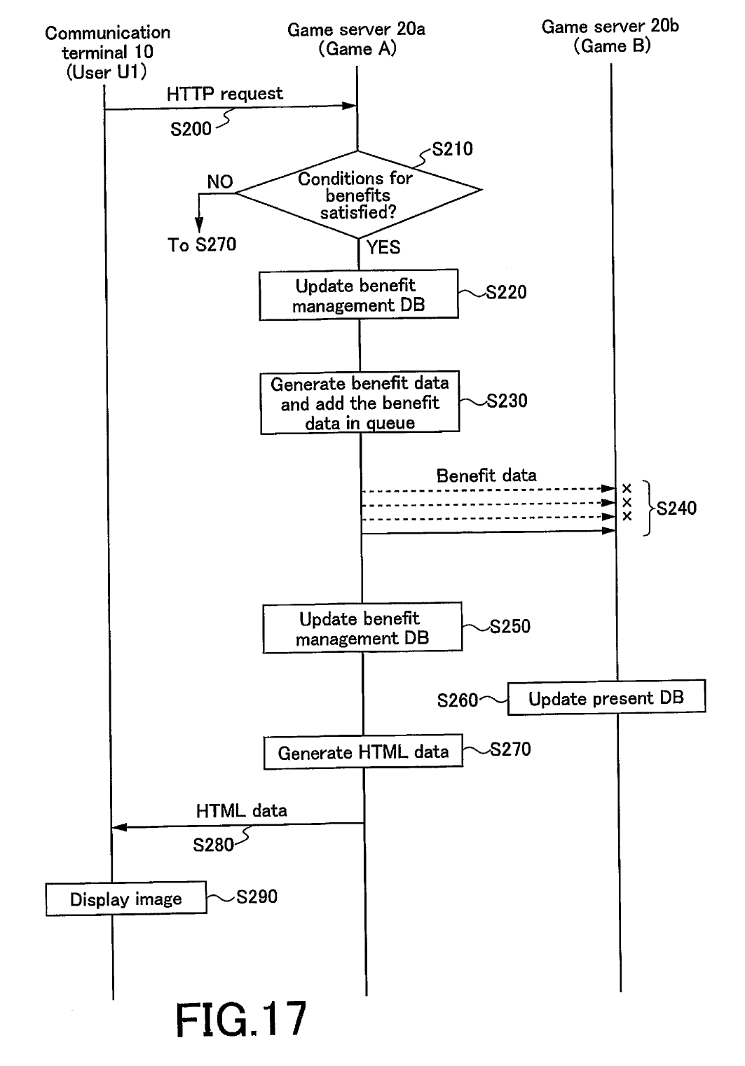

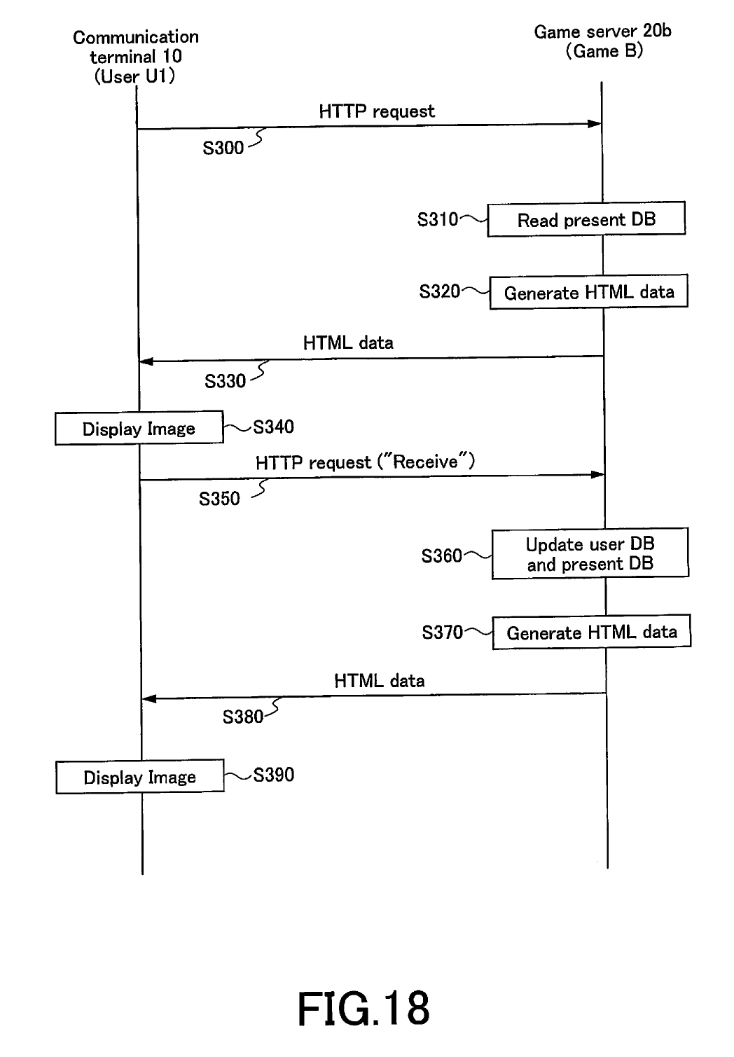

An example of the main processing flow performed in the game system of the present embodiment will be described with reference to sequence charts of FIGS. 16 to 18. Note that FIG. 16 and FIG. 17 indicate processing steps based on determination for the condition for benefits in the joint campaign in the game A. FIG. 18 indicates processing steps for receiving a benefit in the game B. The benefit derives from the joint campaign in the game A.

In FIGS. 16 to 18, a user to be processed is user U1.

In FIG. 16, if user U1 performs a selection operation in the web page of the game A (selection operation to the button m10 or m11 in FIG. 10 while playing the quest, for example), a HTTP request including a result of the selection operation is transmitted from the communication terminal 10 to the game server 20a (Step S200). The CPU 21 of the game server 20a accesses to the benefit management database to determine whether each of the conditions for benefits for which data of “00” (Condition for benefits is not satisfied.) is written, has been satisfied by user U1 (Step S210). For example, in the case in which a condition for benefits is that a progression level reaches Lv2 in the game A, the CPU 21 of the game server 20a refers to user data of user U1 to determine whether a progression level of user U1 is equal to or higher than Lv2. If any one of the conditions for benefits for which data of “00” is written is not satisfied (Step S210: NO), the CPU 21 proceeds to Step S270 and generates HTML data including processing result based on the HTTP request in Step S200.

If any one of the conditions for benefits for which data of “00” is written has been satisfied (Step S210: YES), the CPU 21 of the game server 20a updates the benefit management database (benefit management DB) by rewriting data corresponding to conditions satisfied in the benefit management database, to “10” (Condition for benefits is satisfied, and benefit data is not transmitted.) (Step S220).

Next, the CPU 21 of the game server 20a again accesses to the benefit management database to generate benefit data corresponding to conditions for benefits for which “10” (Condition for benefits is satisfied, and benefit data is not transmitted.) is written. The CPU 21 then adds the benefit data into the benefit data queue in the RAM 23 (Step S230). The benefit data queue includes user ID of user U1 and a content of a benefit provided in the game B.

The CPU 21 of the game server 20a reads benefit data for user U1 from the benefit data queue in the RAM 23, and controls the API server 26 such that a request including the benefit data, which has been read, is transmitted to the API server 26 of the game server 20b (Step S240). The API server 26 of the game server 20a receives a response from the API server 26 of the game server 20b. The response includes a reception result (reception successful, or reception failed) with regard to the benefit data.

After transmission of the benefit data is completed, the CPU 21 of the game server 20a accesses to the benefit management database to rewrite data corresponding to the benefit data that has been transmitted, from “10” (Condition for benefits is satisfied, and benefit data is not transmitted.) to “11” (Condition for benefits is satisfied, and benefit data is transmitted.). Thereby, the benefit management database is updated (Step S250).

If the CPU 21 of the game server 20b receives benefit data through the API server, the CPU 21 updates the present database by writing new data into the present database (present DB; see FIG. 7) based on the received benefit data (Step S260). In this case, the CPU 21 of the game server 20b writes a code indicating that the benefit derives from the joint campaign into the field of “Origin” that corresponds to user ID included in the benefit data. The CPU 21 writes a content of the benefit (identifier indicating a kind of a card, for example) included in the benefit data, into the field of “Content of present.” The CPU 21 writes “0” (Not received) into the field of “Reception status.”

The CPU 21 of the game server 20a proceeds to Step S270 after Step S250, and generates HTML data including a processing result based on the HTTP request in Step S200 (Step S270). The CPU 21 then transmits the generated HTML data to the communication terminal 10 of user U1 (Step S280). The communication terminal 10 of user U1 interprets the received HTML data and displays a web page (Step S290).

The processing steps based on determination for the conditions for benefits in the joint campaign of the game A have been described above. Meanwhile, when the game server 20a transmits the benefit data to the game server 20b (Step S240), the game server 20b may not be able to receive the benefit data since the game B is under maintenance. A situation under which “the game B is under maintenance” is, for example, is a situation under which a service for playing the game B is stopped for a period of time for a reason that a program for executing the game B is updated, etc. FIG. 17 is a sequence chart for processing steps in consideration of the case in which the game B is under maintenance, compared with the sequence chart of FIG. 16.

The sequence chart of FIG. 17 is different from that of FIG. 16 in Step S240. In the case in which the game B is under maintenance, the CPU 21 of the game server 20a repeats transmitting the benefit data every a period of time until the transmission of the benefit data is completed. The CPU 21 of the game server 20a repeats transmitting the benefit data until it receives a result of successful reception through the API server 26.

It is assumed in FIG. 18 that user U1 logs into the game B after a condition for benefits has been satisfied by user U1 in the game A.

If user U1 performs a selection operation to a button (selection operation to the button m25, for example) for displaying a list of presents in a top page (the web page P1b of FIG. 12, for example), the communication terminal 10 transmits a HTTP request including the selection result to the game server 20b (Step S300). The CPU 21 of the game server 20b receives the HTTP request and reads data for user U1 from the present database (present DB) (Step S310). The CPU 21 then generates HTML data including a list of presents (Step S320) and transmits the HTML data to the communication terminal 10 of user U1 (Step S330). The communication terminal 10 of user U1 interprets the received HTML data and display a web page (the web page P2b of FIG. 12, for example) (Step S340).

If user U1 performs a selection operation (selection operation to the button m27, for example) for receiving a benefit from the list of presents displayed in Step S340, the communication terminal 10 transmits a HTTP request including the selection result to the game server 20b (Step S350). The CPU 21 of the game server 20b receives the HTTP request, and updates the user database (user DB) and the present database (present DB) (Step S360). For example, in the case of a card as a content of the benefit, the CPU 21 of the game server 20b accesses to the user data of the user to be processed and writes the card as the benefit in the field of “Owned cards.” Further, the CPU 21 accesses to the present database to rewrite data in the field of “Reception status” corresponding to the benefit to be received by user U1 (that is, the benefit to be provided to user U1), from “0” (Not received) to “1” (Received).

The CPU 21 of the game server 20b generates HTML data in response to a selection operation (selection operation to the button m27, for example) for receiving the benefit (Step S370), and transmits the HTML data to the communication terminal 10 of user U1 (Step S380). The communication terminal 10 of user U1 interprets the received HTML data and display a web page (Step S390). The displayed web page preferably includes a text indicating that the benefit has been provided to user U1.

As described above, it is configured in the game control devices according to the present embodiment that, if a status of execution in the game A (namely, the first game) by a user has satisfied a condition for benefits, the user is provided with a benefit in the game B (namely, the second game). Thereby, the user is motivated to try to play the game A so that any condition for benefits is satisfied in the game A, for the purpose of obtaining the benefit in the game B. Further, it is configured in the game control devices according to the present embodiment that, if a degree of association in the game A (namely, the first game) between the user and other user satisfies a condition, the user will be provided with a benefit in the game B (namely, the second game). Thereby, the user is motivated to establish and strengthen relationship with the other user in the game A so that the degree of association in the game A between the user and other user satisfies the condition, for the purpose of obtaining the benefit in the game B. That is, according to the game control devices of the present embodiment, a demand of a user for obtaining a benefit in the game B that the user has already played is tied to motivation for trying to play the game A. Therefore, it becomes possible to smoothly guide the user to the game A. Particularly in the case in which the game B is well known and the game A is a new game, effect of guiding the user to the game A is high because a lot of users have already played the game B.

In the case in which a user obtains a benefit in the game B due to the joint campaign that has been described in the present embodiment, an entry procedure for the user is not necessary with regard to the joint campaign in the game A or the game B. If the user begins to play the game A without performing any special procedure, and any condition for benefits has been satisfied in the game A, the user will be provided with a benefit in the game B irrespective of whether the user is aware of the joint campaign.

As described in the present embodiment, in the case in which a number of registered users (a number of users having registered) in the game A (namely, the first game) is less than a number of registered users in the game B (namely, the second game), it is preferable that the provider 54 temporarily records benefit data (namely, first information) in a benefit data queue (buffer), transmits the benefit data in the benefit data queue to the game server 20b (namely, the second game control device), and repeats transmitting the benefit data until completion.

In the case in which a number of registered users in the game A is less than a number of registered users in the game B, the game server 20a only requires memory capacity and computation capability that are lower than the game server 20b does. It is reasonable to strengthen processing capability gradually as the number of registered users increases. Thus, the game server 20a may require processing capability for relatively a small number of users, especially in the case in which the game A is a new game and service of the game A has just started.

Meanwhile, a conventional game control device executing a specific game, in providing users with a benefit, determines whether or not to provide the benefit with respect to each of the users. Here, it is assumed that, in order to determine whether a condition has been satisfied for each of a great many registered users of the game B, the game server 20b accesses to the game server 20a whose processing capability is low. Then, as there are many registered users of the game B, there is possibility of occurrence of congestion in the game server 20a of the game A whose processing capability is low. Particularly there is a social network game whose number of registered users is several hundred thousand to several million registered users. If the game B is such social networking game, the game server 20a of the game A may not be able to process accesses. This is because excessive processing load is applied for the game server 20a of the game A in the case in which a great many registered users in the game B, even some of the users, perform an operation for accessing the game server 20a of the game A to determine whether the condition has been satisfied. In view of the above, according to the present embodiment, the game server 20b does not access to the game server 20a of the game A to determine whether the condition has been satisfied. In the game server 20a of the present embodiment, benefit data indicating that the condition is satisfied is temporarily recorded in a buffer, the benefit data in the buffer is transmitted to the game server 20b, and transmission of the benefit data is repeated until the transmission completes. That is, the game server 20a of the game A accesses to the game server 20b whose processing capability is high, for processing with respect to each of relatively fewer registered users. Thereby, the occurrence of congestion can be avoided.

In the present embodiment described above, a condition for benefits may be, but not limited to, that a progression level for a user reaches a predetermined value in the game A (namely, the first game), as exemplified by the web page P2a in FIG. 9. Because the condition is on the basis of the progression level, the user is able to set a quantitative target in progressing the game A in order to obtain the benefit in the game B (namely, the second game). Accordingly, it is possible to make the user clearly conscious of trying to play the game A.

It should be noted that the progression level to be determined is not limited to the progression level of the game A per se, but a progression level of a specific event of the game A (a limited-time event in the game A, for example). In this case, it is possible to guide a user who has played the game A and has not participated in a specific event of the game A, to the specific event.

### (8) Modifications

Modifications of the present embodiment will be described below.

(8-1) Modification 1

In the present embodiment described above, in the case in which a number of registered users (a number of users having registered) in the game A (namely, the first game) is less than a number of registered users in the game B (namely, the second game), the provider 54 may transmit benefit data (namely, first information) to the game server 20b (namely, second game control device) in response to an input of the user.

As described above, in the case in which a number of registered users in the game A (namely, the first game) is less than a number of registered users in the game B (namely, the second game), the game server 20a requires memory capacity and computation capability that are lower than the game server 20b does. Then, the game server 20a of the game A transmits the benefit data indicating that a condition for benefits has been satisfied, to the game server 20b of the game B, in response to an input of the user. Thereby, the game server 20a of the game A accesses to the game server 20b whose processing capability is high, for processing with respect to each of relatively fewer registered users. Thereby, the occurrence of congestion can be avoided in the game server 20a of the game A.

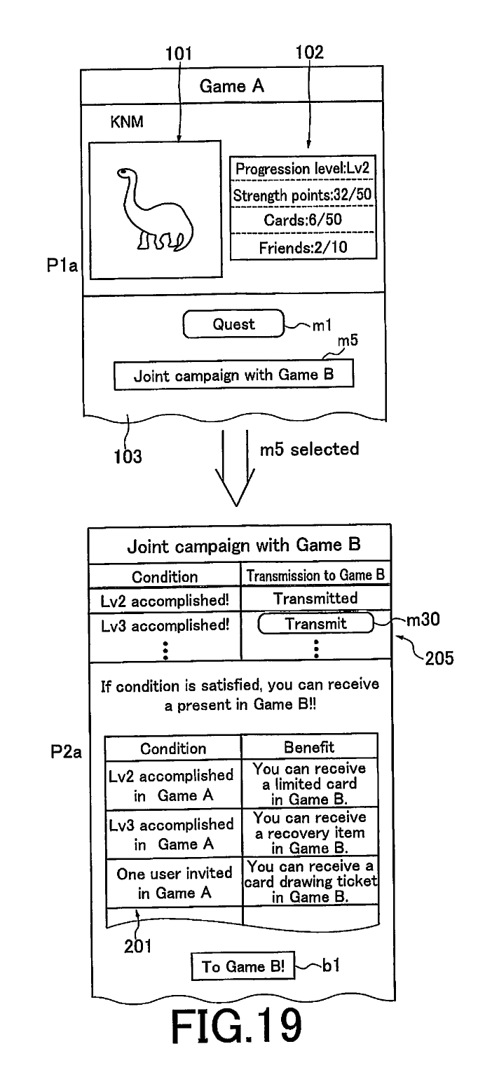

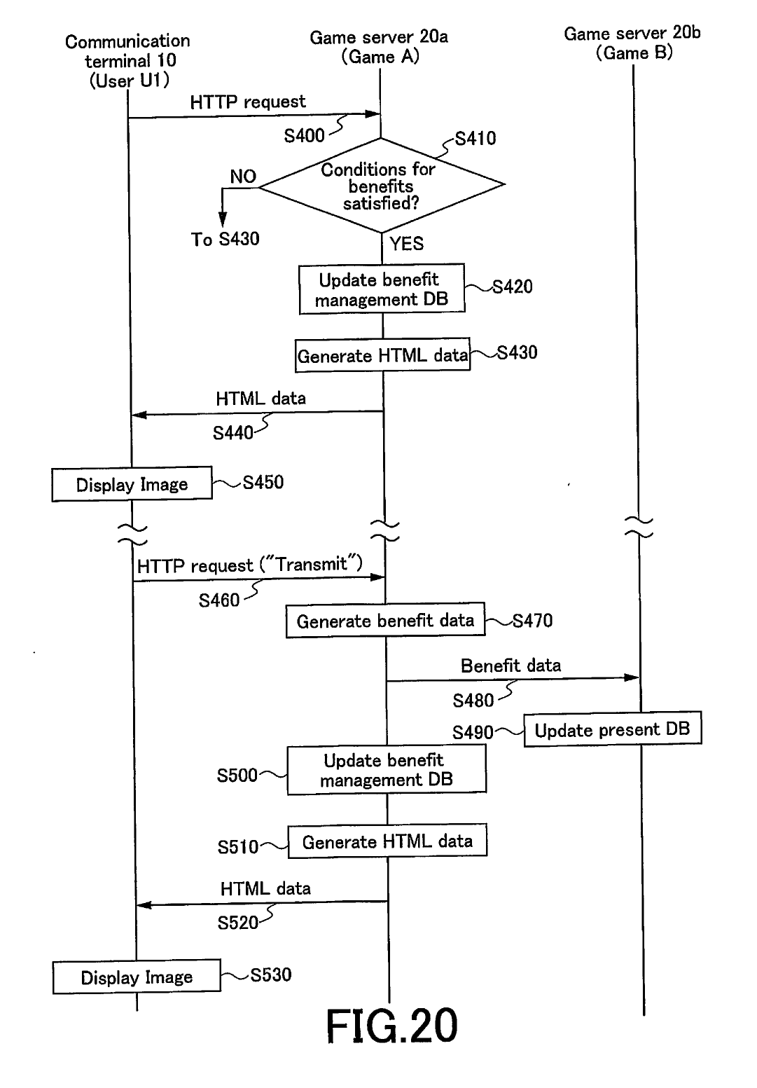

An example for realizing the present modification will be described with reference to FIG. 19 and FIG. 20. FIG. 19 illustrates an example of a series of web pages that are displayed including a content of the joint campaign with the game B according to a modification of the present embodiment. FIG. 20 is a sequence chart for processing steps in the game A based on a determination result for a condition for benefits in the joint campaign according to the modification of the present embodiment.

In the present modification, as illustrated in FIG. 19, if the button m5 is selected in the web page P1a of the game A, the updated web page P2a will be displayed. A display area 205 in the web page P2a includes with respect to each of conditions for benefits that has been satisfied: a text of “Transmitted” that is displayed if corresponding benefit data has been transmitted to the game server 20b; and a button m30 (“Transmit”) that is displayed if corresponding benefit data has not been transmitted to the game server 20b. If the button m30 is selected in the web page P2a, corresponding benefit data will be transmitted to the game server 20b. If the transmission is completed successfully, the display of the button m30, which have been selected, will be switched to the text of “Transmitted.”

In FIG. 20, if user U1 performs a selection operation in the web page of the game A (selection operation to the button m10 or m11 in FIG. 10 while playing the quest, for example), a HTTP request including a result of the selection operation will be transmitted from the communication terminal 10 to the game server 20a (Step S400). The CPU 21 of the game server 20a accesses to the benefit management database to determine whether each of the conditions for benefits for which data of “00” (Condition for benefits is not satisfied.) is written has been satisfied by user U1 (Step S410). For example, in the case in which a condition for benefits is that a progression level reaches Lv2 in the game A, the CPU 21 of the game server 20a refers to user data of user U1 to determine whether a progression level of user U1 is equal to or higher than Lv2. If any one of the conditions for benefits for which data of “00” is written has been satisfied (Step S410: YES), the CPU 21 of the game server 20a updates the benefit management database (benefit management DB) by rewriting data corresponding to conditions that have been satisfied in the benefit management database, to “10” (Condition for benefits is satisfied, and benefit data is not transmitted.) (Step S420). If any one of the conditions for benefits for which data of “00” is written is not satisfied (Step S410: NO), the CPU 21 of the game server 20a does not update the benefit management database.

Next, the CPU 21 of the game server 20a generates HTML data including processing result based on the HTTP request in Step S400 (Step S430). The CPU 21 then transmits the generated HTML data to the communication terminal 10 of user U1 (Step S440). The communication terminal 10 of user U1 interprets the received HTML data and displays a web page (Step S450).

In the present modification, different from the sequence chart of the present embodiment illustrated in FIG. 16, benefit data is not automatically transmitted even if any condition for benefits has been satisfied. That is, at a time a condition for benefits has been satisfied, the only processing step performed is that the benefit management database is updated.

If a user accesses to a campaign page (web page P2a of FIG. 19, for example) at a desired time after a condition for benefits has been satisfied, and the user selects the button m30 (“Transmit”) is selected that corresponds to any condition for benefits that has been satisfied, then the communication terminal 10 will transmit a HTTP request including a result of the selection operation, to the game server 20a (Step S460). After receiving the HTTP request, the CPU 21 of the game server 20a accesses to the benefit management database to generate benefit data corresponding to conditions for benefits for which “10” (Condition for benefits is satisfied, and benefit data is not transmitted.) is written (Step S470). The CPU 21 of the game server 20a controls the API server 26 such that a request including the benefit data is transmitted to the API server 26 of the game server 20b (Step S480). The API server 26 of the game server 20a receives a response from the API server 26 of the game server 20b. The response includes a reception result (reception successful, or reception failed) with regard to the benefit data.

If the CPU 21 of the game server 20b receives benefit data through the API server, the CPU 21 updates the present database by writing new data into the present database (present DB; see FIG. 7) based on the received benefit data (Step S490). In this case, the CPU 21 of the game server 20b writes a code indicating that the benefit derives from the joint campaign into the field of “Origin” that corresponds to user ID included in the benefit data. The CPU 21 writes a content of the benefit (identifier indicating a kind of a card, for example) included in the benefit data, into the field of “Content of present.” The CPU 21 writes “0” (Not received) into the field of “Reception status.”

After the benefit data is successfully transmitted, the CPU 21 of the game server 20a accesses to the benefit management database to rewrite data corresponding to the benefit data that has been transmitted, from “10” (Condition for benefits is satisfied, and benefit data is not transmitted.) to “11” (Condition for benefits is satisfied, and benefit data is transmitted.). Thereby, the benefit management database is updated (Step S500). The CPU 21 of the game server 20a generates HTML data including a processing result based on the HTTP request at Step S460 (Step S510), and transmits the HTML data to the communication terminal 10 of user U1 (Step S520). The communication terminal 10 of user U1 interprets the received HTML data and display a web page (Step S530).

(8-2) Modification 2

In the present embodiment described above, the provider 54 may simultaneously transmit the benefit data (namely, first information) with respect to a plurality of users at set time intervals.

In the present embodiment described above, if the determiner 53 determines that a condition for benefits has been satisfied, benefit data (namely, first information) is immediately written into the benefit data queue and then transmitted to the game server 20b (namely, second game control device). Thus, it is required that the game server 20b receive the benefit data and perform processing steps based on the received benefit data, every time the benefit data is transmitted. In contrast, in the present modification, benefit data with respect to a plurality of users are simultaneously transmitted at set time intervals. Then, the game server 20b can perform batch processing with regard to a plurality of benefit data at a fixed time. Accordingly, stationary load applied for the game server 20b is reduced. A time when the benefit data are transmitted may be preferably, but not limited to, in a range of hours during which stationary load is low (that is, hour during which accesses from users are relatively few), such as hours in the middle of the night.

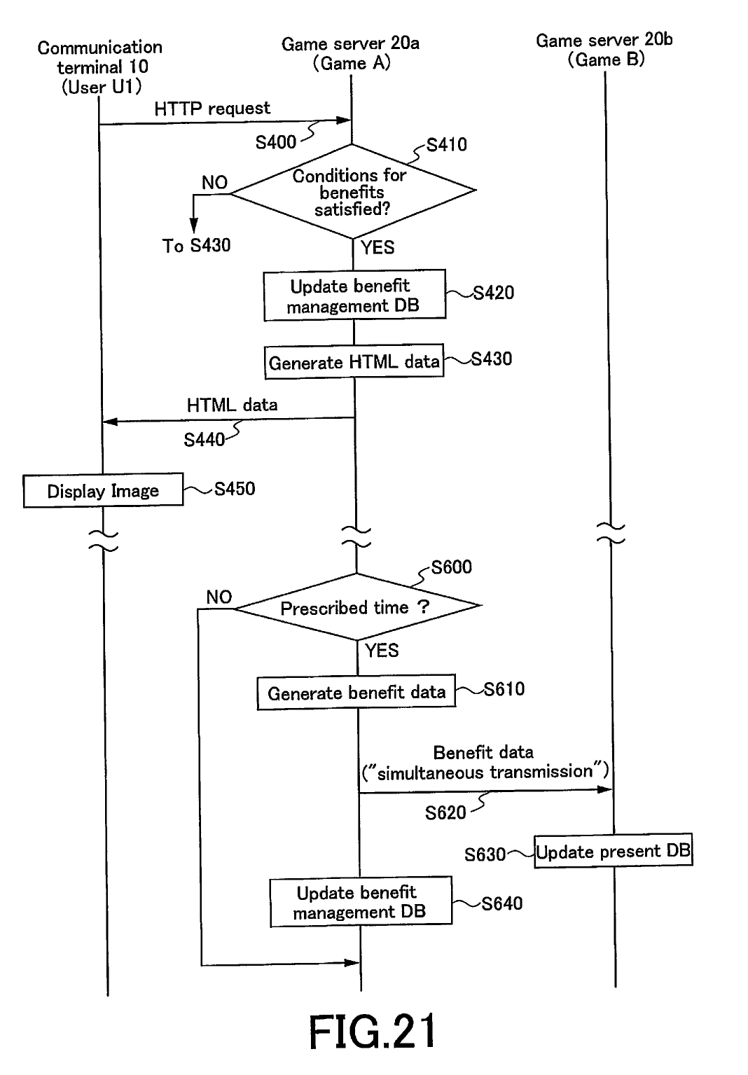

It will be explained how the present modification is realized with reference to FIG. 21. FIG. 21 is a sequence chart for processing steps based on a determination result for a condition for benefits in a joint campaign of the game A according to a modification of the present embodiment. With respect to the same processing steps in FIG. 21 as those in FIG. 20, the same signs are affixed and repeated explanation will be omitted.

In FIG. 21, if the current time reaches a prescribed time every day (S600: YES), the CPU 21 of the game server 20a will access to the benefit management database to generate, with respect to all users, benefit data corresponding to conditions for benefits for which “10” (Condition for benefits is satisfied, and benefit data is not transmitted.) are written (Step S610). Then, the CPU 21 of the game server 20a controls the API server 26 such that a request including a plurality of benefit data is transmitted to the API server 26 of the game server 20b (Step S620). The API server 26 of the game server 20a receives a response from the API server 26 of the game server 20b. The response includes a reception result (reception successful, or reception failed) with regard to the benefit data.

For example, in the case in which the prescribed time at Step S600 is set to be 3 a.m. and 3 p.m., a plurality of benefit data are simultaneously transmitted at 3 PM based on determination results made during a period from 3 a.m. to 3 p.m., while a plurality of benefit data are simultaneously transmitted at 3 a.m. based on determination results made during a period from 3 p.m. to 3a.m.

If the CPU 21 of the game server 20b receives the plurality of benefit data through the API server, the CPU 21 updates the present database by writing new data into the present database (present DB; see FIG. 7) based on the received plurality of benefit data (Step S630). After the plurality of benefit data are successfully transmitted, the CPU 21 of the game server 20a accesses to the benefit management database to rewrite data corresponding to all benefit data that has been transmitted, from “10” (Condition for benefits is satisfied, and benefit data is not transmitted.) to “11” (Condition for benefits is satisfied, and benefit data is transmitted.). Thereby, the benefit management database is updated (Step S640).

(8-3) Modification 3

In the present embodiment described above, the benefit provided in the game B may be increased as the progression level increases.

According to this configuration, the benefit that a user can obtain in the game B (namely, second game) is increased as the user progresses the game A (namely, first game). Thus, the user's eagerness in playing the game A is increased, because the user is motivated to obtain as many benefits as possible in the game B.

In realizing the present modification, relation between a degree of progression in the game A and a benefit provided in the game B may be properly set. The following is an example of the relation.

| Degree of progression (game A) | Benefit (game B) | |
|---|---|---|
| Completion of a tutorial → | | One recovery item |
| Progression level Lv2 | → | Two recovery items |
| Progression level Lv3 | → | Three recovery items |
| Progression level Lv4 | → | Four recovery items |

(8-4) Modification 4

In the present embodiment described above, the provider 54 may provide the game server 20b with the benefit data (namely, first information) irrespective of whether a user is registered in the game B (namely, second game), and the notifier 55 may notify the user irrespective of whether the user is registered in the game B (namely, second game).

According to this configuration, even in the case in which a user is not registered in the game B at a time when a condition for benefits is satisfied with regard to the game A, the user is provided with a benefit after the user is registered in the game B.

The present modification will be realized as described below. The CPU 21 of the game server 20b of the game B receives benefit data. If the CPU 21 does not recognize user ID in the game corresponding to user ID included in the received benefit data (if the corresponding user ID does not exist in the user database of the game B, for example), the CPU 21 cannot update the present database. Thus, the CPU 21 records the benefit data in the game database 32 of the database server 30b, for example. Then, after the user performs user registration and accordingly the CPU 21 of the game server 20b recognizes the user ID included in the benefit data that has been recorded, the CPU 21 updates the present database based on the benefit data.

(8-5) Modification 5

In the present embodiment described above, the determiner 53 may limit a user to be determined, based on registered information for the user.

By limiting users to be determined, processing load for determination in the game server 20a of the game A can be reduced. Further, since users to be determined are limited based on registered information for the users, it becomes possible to effectively guide the users to be determined, to the game A (namely, first game), while reducing processing load.

In realizing the present modification, the game server 20a acquires registered information such as sex, age, address, or occupation of a user, identification information of the communication terminal of a user, or mail address of a user, through a user input upon user registration. In the case in which an upper layer server (a server of a platform-provider providing a platform for games, for example; not shown) of respective game servers 20 records the registered information, the game server 20a may acquire the registered information from the upper layer server through the API server 26.

The CPU 21 of the game server 20a identifies a user according to a specific known user identification method based on the registered information. The CPU 21 of the game server 20a identifies a user according to the user identification method upon user registration of the user, and manages data of the identified user in the benefit management database. Therefore, a user who is not managed in the benefit management database (that is, a user who has not been identified) is not provided with a benefit in the game B, since benefit data is not transmitted even if a condition for benefits has been satisfied.

In the present modification, the registered information may be preferably at least one of sex and age. That is, the known user identification method is applied for identifying a user whose registered information satisfies a criteria with regard to at least one of sex and age.

For example, the user identification method may be one for identifying a user with a criteria that a user is female. In the case of the game A (namely, first game) directed for female users, it is assumed that female users, rather than male users, are willing to try to play the game A. In this case, by limiting users to be determined to female users based on the registered information, it becomes possible to guide female users to the game A, while reducing processing load for determination. Alternatively, in the case in which game characters that appear in the game A (namely, first game) are animals, insects, or the like, users to be determined may be limited to junior high school students or younger (that is, users of age equal to or less than junior high school students).

The exemplary embodiment of the present invention has been explained in detail. However, the present invention is not limited to the aforementioned exemplary embodiment. Further, it is apparent that a variety of changes and modifications can be made for the exemplary embodiment without departing from the scope of the present invention. For example, technical matters that are described in the embodiment and the modifications may be combined.

In the embodiment described above, an operational input is an input of pressing an operational button on the communication terminal of a user, or an input of a touch operation to a display screen of the communication terminal that includes a touch panel function; however, an operational input is not limited to these examples. The operational input may be an operational input by swinging the communication terminal having an acceleration sensor, or may be an operational input by a gesture (gesture input). If a gesture is performed to a communication terminal having an imaging function, the communication terminal captures an image of the gesture and recognizes an operational input that corresponds to the gesture. Further, in the case of a communication terminal in which voice recognition program is executable, an operational input may be a voice input.

In the present embodiment described above, communication between game servers 20 and communication between a game server 20 and an upper layer server are performed according to HTTP using Web API; however, the present invention is not limited to communication according to HTTP. The other known protocol for wired or wireless communication may be applied.

While an example has been described in which a social network game is realized, the game for which the present invention may be applied is not limited to the social network game. For example, an online game system may be applied in which a server device on a network and a home online game machine are connected. With such online game system, progress of the game can be controlled in the same way as the embodiments described above.

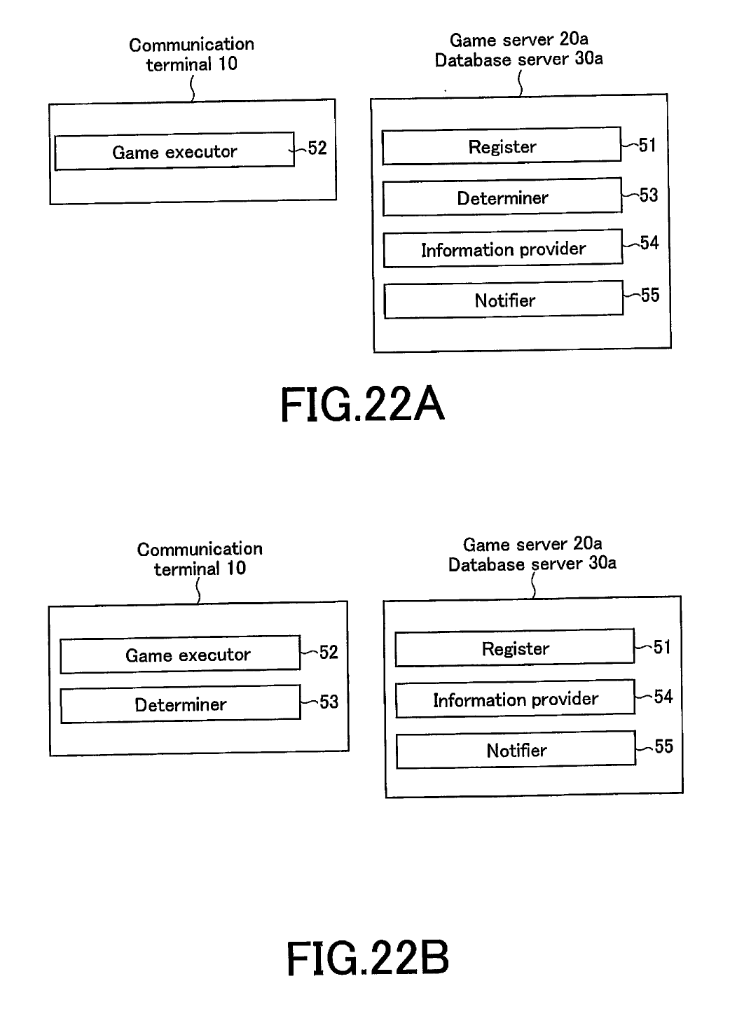

In the embodiments described above, the functions included in respective means illustrated in FIG. 13 are configured to be realized by the game server 20a and the database server 30a on a network; however, the present invention is not limited to such configuration. At least one of the means in FIG. 13 may be configured to be realized by the communication terminal 10. Because the communication terminal 10 and the game server 20 may involve the substantially same hardware configuration, the functions can be also realized by the communication terminal 10 as described in the above embodiments. FIGS. 22A and 22B each illustrates an example of configuration in which the functions (ones illustrated in FIG. 13) of the first game control device of the present embodiment are shared between the communication terminal 10, and the game server 20a and the database server 30a.

### APPENDIX

Aspects of the present invention are disclosed hereinafter.

A first aspect of the present invention is a first game control device for a first game including:

an executor configured to execute the first game;

a determiner configured to determine whether at least one of a status of execution in the first game played by a user, and a degree of association in the first game between the user and another user satisfies a condition;

a provider configured to provide a second game control device that executes a second game, with first information indicating that the condition is satisfied, after the determiner determines that the condition has been satisfied; and

a notifier configured to notify the user that the user can receive a benefit in the second game, after the determiner determines that the condition has been satisfied.

In the first game control device described above, the “condition” is preferably, but not limited to, an attainable condition that the user can satisfy relatively easily in the first game. That is, the “condition” is preferably so relaxed that the user does not hesitate to try to play the first game.

In the first game control device described above, an example of a case in which “status of execution in a game satisfies a condition” may be: a case in which a degree of progression in the game or a total period of time for executing the game exceeds a prescribed value; or a case in which displaying or processing a tutorial of a game has been completed, if the tutorial is supposed to be displayed when a user to be determined first accesses to the first game.

In the first game control device described above, an example of a case in which “degree of association in a game between a user and other user satisfies a condition” may be, for example: a case in which the user invites the other user in the game and the other user is registered in the game; the user and the other user are friends in the game; or a degree of intimacy between the user and the other user is equal to or higher than a predetermined value.

It is configured in the first game control device according to the present invention that, if a status of execution in the first game played by a user has satisfied a condition, the user is provided with a benefit in the second game. Thereby, the user is motivated to try to play the first game so that the status of execution in the first game played by the user satisfies the condition, for the purpose of obtaining the benefit in the second game. Further, it is configured that, if a degree of association in the first game between the user and other user has satisfied a condition, the user is provided with a benefit in the second game. Thereby, the user is motivated to establish and strengthen relationship with the other user in the first game so that the degree of association in the first game between the user and other user satisfies the condition, for the purpose of obtaining the benefit in the second game. That is, according to the first game control device of the present invention, a demand of a user for obtaining a benefit in the second game that the user has already played is tied to motivation for trying to play the first game. Therefore, it becomes possible to smoothly guide the user to the first game. Particularly in the case in which the second game is well known and the first game is a new game, effect of guiding the user to the first game is high because a lot of users have already played the second game.

It should be noted that, in providing a user with a benefit in the second game, any procedure (an entry procedure, for example) is not necessarily required in the first game or the second game.

The first game and the second game may be executable after completion of user registration, and a number of users having registered in the first game is less than a number of users having registered in the second game. Further, the provider may be configured to temporarily record the first information in a buffer, to transmit the first information in the buffer to the second game control device, and to repeat transmission of the first information until completion.

According to this configuration, because a number of registered users (that is, a number of users having registered) in the first game is less than a number of registered users in the second game, the first game control device of the present invention requires memory capacity and computation capability that are lower than the second game control device does. It is reasonable to strengthen processing capability gradually as the number of registered users increases. Thus, the control device for the first game may require processing capability for relatively a small number of users especially in the case in which the first game is a new game and service of the first game has just started.

Meanwhile, a conventional game control device executing a specific game, in providing users with a benefit, determines whether or not to provide the benefit with respect to each of the users. Here, it is assumed that, in order to determine if a condition has been satisfied for each of a great many registered users of the second game, the second game control device accesses to the first game control device whose processing capability is low. Then, as there are many registered users of the second game, there is possibility of occurrence of congestion in the first game control device of the first game whose processing capability is low. Particularly there is a social network game whose number of registered users is several hundred thousand to several million registered users. If the second game is such social networking game, the first game control device of the first game may not be able to process accesses. This is because excessive processing load is applied for the first game control device of the first game in the case in which a great many registered users in the second game, even some of the users, perform an operation for accessing the first game control device of the first game to determine whether the condition has been satisfied. In view of the above, according to the present invention, the second game control device does not access to the first game control device of the first game to determine whether the condition has been satisfied. In the game control device of the present invention (the first game control device of the first game), first information indicating that the condition is satisfied is temporarily recorded in a buffer, the first information in the buffer is transmitted to the second game control device, and transmission of the first information is repeated until completion. That is, the first game control device of the first game accesses to the second game control device whose processing capability is high, for processing with respect to each of relatively fewer registered users. Thereby, occurrence of congestion can be avoided.

The first game and the second game may be executable after completion of user registration, and a number of users having registered in the first game is less than a number of users having registered in the second game, and the provider may be configured to transmit the first information to the second game control device in response to an input of the user.

According to this configuration, because a number of registered users in the first game is less than a number of registered users in the second game, the first game control device of the first game only requires memory capacity and computation capability that are lower than the second game control device does.

Further, the first game control device may transmit the first information to the second game control device in response to an input of the user. That is, the first game control device of the first game accesses to the second game control device whose processing capability is high, for processing with respect to each of relatively fewer registered users. Thereby, occurrence of congestion can be avoided.

In the first game control device, the provider may be configured to simultaneously transmit the first information to the second game control device at set time intervals.

In the case in which the first information is transmitted to the second game control device immediately after the determiner determines that the condition has been satisfied, the second game control device needs to receive the first information and perform processing based on the received first information. In contrast, in the case in which the first information with regard to a plurality of users is simultaneously transmitted to the second game control device at set time intervals, the second game control device can perform batch processing with regard to a plurality of first information at a fixed time. Accordingly, stationary load applied for the second game control device is reduced. A time when the first information is transmitted may be preferably, but not limited to, in a range of hours during which stationary load is low (that is, hour during which accesses from users are relatively few), such as hours in the middle of the night.

In the first game control device, the condition may be that a level reaches a predetermined value, the level indicating a degree of progression by the user in the first game or a degree of progression by the user in an event of the first game.

According to this configuration, the condition under which a benefit is provided in the second game is that a level (namely, progression level) indicating a degree of progression by a user in the first game reaches a predetermined value. Thus, the user is able to set a quantitative target in progressing the first game in order to obtain the benefit in the second game. Accordingly, it is possible to make the user clearly conscious of trying to play the first game.

It should be noted that the progression level to be determined is not limited to the progression level of the first game per se, but a progression level of a specific event of the first game (a limited-time event in the first game, for example). In this case, it is possible to guide a user who has played the first game and has not participated in a specific event of the first game, to the specific event.

In the first game control device, the benefit may be increased as the level increases.

According to this configuration, the benefit that a user can obtain in the second game is increased as the user progresses the first game. Thus, the user's eagerness in playing the first game is increased, because the user is motivated to obtain as many benefits as possible in the second game.

The first game and the second game may be executable after completion of user registration. Further, the provider may be configured to provide the second game control device with the first information, irrespective of whether the user is registered in the second game, and the notifier may be configured to notify the user, irrespective of whether the user is registered in the second game.

According to this configuration, even in the case in which a user is not registered in the second game at a time when the condition is satisfied with regard to the first game, the user is provided with the benefit after the user is registered in the second game.

In the first game control device, the determiner may be configured to limit a user to be determined, based on registered information for the user.

According to this configuration, because users to be determined are limited, processing load for determination in the first game control device can be reduced. Further, since users to be determined are limited based on registered information for the users, it becomes possible to effectively guide the users to be determined, to the first game, while reducing processing load.

In the first game control device, the registered information may be at least one of sex and age. In the case in which the first game is directed for female users for example, it is assumed that female users, rather than male users, are willing to try to play the first game. In this case, by limiting users to be determined to female users based on the registered information, it becomes possible to guide female users to the first game, while reducing processing load for determination. Alternatively, in the case in which game characters that appear in the first game are animals, insects, or the like, users to be determined may be limited to junior high school students or younger (that is, users of age equal to or less than junior high school students).

A second aspect of the present invention is a non-transitory computer-readable recording medium containing a program for enabling a computer to perform a method, the method including:

executing a first game;

determining whether at least one of a status of execution in the first game played by a user, and a degree of association in the first game between the user and another user satisfies a condition;

providing a device that executes a second game, with first information indicating that the condition is satisfied, after the condition has been satisfied; and

notifying the user that a benefit has been received in the second game, after the condition has been satisfied.

An example of such recording medium is DVD-ROM and CD-ROM.

A third aspect of the present invention is a game control method between a first server and a second server, the first server executing a first game in response to access from a communication terminal, the second server executing a second game in response to access from a communication terminal, the method including:

determining, by the first server, whether at least one of a status of execution in the first game played by a user, and a degree of association in the first game between the user and another user satisfies a condition;

providing, by the first server, the second server that executes a second game, with first information indicating that the condition is satisfied, after the determiner determines that the condition has been satisfied;

notifying, by the second server, the user that a benefit has been provided in the second game, after the determiner determines that the condition has been satisfied; and

providing, by the second server, the user with a benefit in the second game based on the first information.

A fourth aspect of the present invention is a game system including a first server and a second server, the first server executing a first game in response to access from a communication terminal, the second server executing a second game in response to access from a communication terminal,

the first server including:
an executor configured to execute a first game;
a determiner for determining whether at least one of a status of execution in the first game played by a user, and a degree of association in the first game between the user and another user satisfies a condition;
a provider configured to provide the second server that executes a second game, with first information indicating that the condition is satisfied, after the determiner determines that the condition has been satisfied; and
a notifier configured to notify the user that the user can receive a benefit in the second game, after the determiner determines that the condition has been satisfied,

the second server comprising a benefit provider for providing the user with a benefit in the second game based on the first information.

What is claimed is:

1. A first game control device for a first game comprising:
an executor configured to execute the first game;
a determiner configured to determine whether at least one of a status of execution in the first game played by a user, and a degree of association in the first game between the user and another user satisfies a condition;
a provider configured to provide a second game control device that executes a second game, with first information indicating that the condition is satisfied, after the determiner determines that the condition has been satisfied; and
a notifier configured to notify the user that the user can receive a benefit in the second game, after the determiner determines that the condition has been satisfied.

2. A first game control device according to claim 1, wherein
the first game and the second game are executable after completion of user registration, and a number of users having registered in the first game is less than a number of users having registered in the second game, and
the provider is configured to temporarily record the first information in a buffer, to transmit the first information in the buffer to the second game control device, and to repeat transmission of the first information until completion.

3. A first game control device according to claim 1, wherein
the first game and the second game are executable after completion of user registration, and a number of users having registered in the first game is less than a number of users having registered in the second game, and
the provider is configured to transmit the first information to the second game control device in response to an input of the user.

4. A first game control device according to claim 1,
wherein the provider is configured to simultaneously transmit the first information to the second game control device at set time intervals.

5. A first game control device according to claim 1,
wherein the condition is that a level reaches a predetermined value, the level indicating a degree of progression by the user in the first game or a degree of progression by the user in an event of the first game.

6. A first game control device according to claim 2,
wherein the condition is that a level reaches a predetermined value, the level indicating a degree of progression by the user in the first game or a degree of progression by the user in an event of the first game.

7. A first game control device according to claim 3,
wherein the condition is that a level reaches a predetermined value, the level indicating a degree of progression by the user in the first game or a degree of progression by the user in an event of the first game.

8. A first game control device according to claim 4,
wherein the condition is that a level reaches a predetermined value, the level indicating a degree of progression by the user in the first game or a degree of progression by the user in an event of the first game.

9. A first game control device according to claim 5,
wherein the benefit is increased as the level increases.

10. A first game control device according to claim 6,
wherein the benefit is increased as the level increases.

11. A first game control device according to claim 7,
wherein the benefit is increased as the level increases.

12. A first game control device according to claim 8,
wherein the benefit is increased as the level increases.

13. A first game control device according to claim 1, wherein the first game and the second game are executable after completion of user registration, wherein
the provider is configured to provide the second game control device with the first information, irrespective of whether the user is registered in the second game, and
the notifier is configured to notify the user, irrespective of whether the user is registered in the second game.

14. A first game control device according to claim 2, wherein the first game and the second game are executable after completion of user registration, wherein
the provider is configured to provide the second game control device with the first information, irrespective of whether the user is registered in the second game, and
the notifier is configured to notify the user, irrespective of whether the user is registered in the second game.

15. A first game control device according to claim 3, wherein the first game and the second game are executable after completion of user registration, wherein
the provider is configured to provide the second game control device with the first information, irrespective of whether the user is registered in the second game, and
the notifier is configured to notify the user, irrespective of whether the user is registered in the second game.

16. A first game control device according to claim 1, wherein the determiner is configured to limit a user to be determined, based on registered information for the user.

17. A first game control device according to claim 16, wherein the registered information is at least one of sex and age.

18. A non-transitory computer-readable recording medium containing a program for enabling a computer to perform a method, the method comprising:
executing a first game;
determining whether at least one of a status of execution in the first game played by a user, and a degree of association in the first game between the user and another user satisfies a condition;
providing a device that executes a second game, with first information indicating that the condition is satisfied, after the condition has been satisfied; and
notifying the user that a benefit has been received in the second game, after the condition has been satisfied.

19. A game control method between a first server and a second server, the first server executing a first game in response to access from a communication terminal, the second server executing a second game in response to access from a communication terminal, the method comprising:
determining, by the first server, whether at least one of a status of execution in the first game played by a user, and a degree of association in the first game between the user and another user satisfies a condition;
providing, by the first server, the second server that executes a second game, with first information indicating that the condition is satisfied, after the condition has been satisfied;
notifying, by the second server, the user that a benefit has been provided in the second game, after the condition has been satisfied; and
providing, by the second server, the user with a benefit in the second game based on the first information.

20. A game system including a first server and a second server, the first server executing a first game in response to access from a communication terminal, the second server executing a second game in response to access from a communication terminal,
the first server comprising:
an executor configured to execute a first game;
a determiner for determining whether at least one of a status of execution in the first game played by a user, and a degree of association in the first game between the user and another user satisfies a condition;
a provider configured to provide the second server that executes a second game, with first information indicating that the condition is satisfied, after the determiner determines that the condition has been satisfied; and
a notifier configured to notify the user that the user can receive a benefit in the second game, after the determiner determines that the condition has been satisfied,
the second server comprising a benefit provider for providing the user with a benefit in the second game based on the first information.
